(19) United States
(12) Patent Application Publication
(10) Pub. No.: US 2023/0180299 A1
(43) Pub. Date: Jun. 8, 2023

(54) METHOD AND APPARATUS FOR RANDOM ACCESS

(71) Applicant: Telefonaktiebolaget LM Ericsson (publ), Stockholm (SE)

(72) Inventors: Zhipeng Lin, Nanjing (CN); Johan Rune, Lidingö (SE)

(21) Appl. No.: 17/917,621

(22) PCT Filed: Apr. 2, 2021
(86) PCT No.: PCT/CN2021/085358

§ 371 Date: Oct. 7, 2022

(30) Foreign Application Priority Data
Apr. 8, 2020 (CN) PCT/CN2020/083715

(51) Int. Cl. H04W 74/08; H04W 72/0446

(52) U.S. Cl. CPC H04W 74/0833; H04W 72/0446

(57) ABSTRACT

Various embodiments of the present disclosure provide a method for random access. The method which may be performed by a terminal device comprises determining resource for a physical uplink shared channel of a two-step contention-free random access procedure. The method further comprises transmitting the physical uplink shared channel with a preamble in one message to a network node in the two-step contention-free random access procedure, according to the determined resource. According to various embodiments of the present disclosure, the physical uplink shared channel resource may be determined or configured for a two-step contention-free random access procedure in a flexible and efficient way, so that the performance of the random access procedure can be improved.

### FIELD OF THE INVENTION

The present disclosure generally relates to communication networks, and more specifically, to a method and apparatus for random access.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long-term evolution (LTE) and new radio (NR) networks are expected to achieve high traffic capacity and end-user data rate with lower latency. In order to connect to a network node, a random access (RA) procedure may be initiated for a terminal device. In the RA procedure, system information (SI) and synchronization signals (SS) as well as the related radio resource and transmission configuration can be informed to the terminal device by signaling messages from the network node. The RA procedure can enable the terminal device to establish a session for a specific service with the network node.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

A wireless communication network such as a NR/5G network may be able to support flexible network configurations. Different signaling approaches (e.g., a four-step approach, a two-step approach, etc.) may be used for a RA procedure of a terminal device to set up a connection with a network node. In the RA procedure, the terminal device may perform a RA preamble transmission and a physical uplink shared channel (PUSCH) transmission to the network node in different messages (e.g., in message 1/msg1 and message 3/msg3 for four-step RA, respectively) or in the same message (e.g., in message A/msgA for two-step RA). The RA preamble may be transmitted in a time-frequency physical random access channel (PRACH) occasion (which is also known as a RA occasion, RACH occasion, or RO for short). The PUSCH transmission may occur in a PUSCH occasion (PO) configured with one or more demodulation reference signal (DMRS) resources. In different RA procedures, e.g. contention-based random access (CBRA) and contention-free random access (CFRA), PUSCH transmissions may be performed according to different configurations. For a two-step CBRA procedure, the msgA PUSCH configuration may provide multiple sets of PUSCH resource units (PRUs). In this document, a PRU may refer to a PO with the associated DMRS resource. For a two-step CFRA procedure, configuring multiple sets of PRUs per PRACH slot may not be optimal, considering that dedicated msgA PUSCH resources may be used in the two-step CFRA procedure. Therefore, it may be desirable to implement msgA PUSCH configuration for the two-step CFRA procedure more efficiently.

Various embodiments of the present disclosure propose a solution for RA, which can determine the msgA PUSCH resource, e.g. one or more PRUs, for a two-step CFRA procedure, for example, according to adaptive mapping between msgA preambles in a RO and associated PRUs, so as to implement the msgA PUSCH configuration for two-step CFRA in a flexible and efficient way.

It can be appreciated that the terms “four-step RA procedure” and “four-step RACH procedure” mentioned herein may also be referred to as Type-1 random access procedure as defined in the 3rd generation partnership project (3GPP) technical specification (TS) 38.213 V16.1.0, where the entire content of this technical specification is incorporated into the present disclosure by reference. These terms may be used interchangeably in this document.

Similarly, it can be appreciated that the terms “two-step RA procedure” and “two-step RACH procedure” mentioned herein may also be referred to as Type-2 random access procedure as defined in 3GPP TS 38.213 V16.1.0, and these terms may be used interchangeably in this document.

In addition, it can be appreciated that a two-step CFRA procedure described in this document may refer to a contention-free random access procedure in which a terminal device is configured to transmit a msgA to a network node as a first step, and a msgB in response to the msgA is expected to be received from the network node by the terminal device as a second step. It can be appreciated that the term “two-step CFRA” mentioned herein may also be referred to as “CFRA with two-step RA type” or “contention-free Type-2 random access”, and these terms may be used interchangeably in this document.

Similarly, it can be appreciated that a two-step CBRA procedure described in this document may refer to a contention-based random access procedure in which a terminal device is configured to transmit a msgA to a network node as a first step, and a msgB in response to the msgA is expected to be received from the network node by the terminal device as a second step. It can be appreciated that the term “two-step CBRA” mentioned herein may also be referred to as “CBRA with two-step RA type” or “contention-based Type-2 random access”, and these terms may be used interchangeably in this document.

It can be realized that the terms “PRACH occasion”, “random access channel (RACH) occasion” or “RA occasion” mentioned herein may refer to a time-frequency resource usable for the preamble transmission in a RA procedure, which may also be referred to as “random access occasion (RO)”. These terms may be used interchangeably in this document.

Similarly, it can be realized that the terms “PUSCH occasion”, “uplink shared channel occasion” or “shared channel occasion” mentioned herein may refer to a time-frequency resource usable for PUSCH transmission in a RA procedure, which may also be referred to as “physical uplink shared channel occasion (PO)”. These terms may be used interchangeably in this document.

According to a first aspect of the present disclosure, there is provided a method performed by a terminal device such as a user equipment (UE). The method comprises determining resource for a PUSCH of a two-step CFRA procedure. In accordance with some exemplary embodiments, the method further comprises transmitting the PUSCH with a preamble in one message (e.g. message A, etc.) to a network node in the two-step CFRA procedure, according to the determined resource.

In accordance with some exemplary embodiments, the method according to the first aspect of the present disclosure may further comprise: receiving, from the network node, signaling information for message A PUSCH transmission of the two-step CFRA procedure.

According to a second aspect of the present disclosure, there is provided an apparatus which may be implemented as a terminal device. The apparatus comprises one or more processors and one or more memories comprising computer program codes. The one or more memories and the computer program codes are configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a terminal device. The apparatus comprises a determining unit and a transmitting unit. In accordance with some exemplary embodiments, the determining unit is operable to carry out at least the determining step of the method according to the first aspect of the present disclosure. The transmitting unit is operable to carry out at least the transmitting step of the method according to the first aspect of the present disclosure.

According to a fifth aspect of the present disclosure, there is provided a method performed by a network node such as a base station. The method comprises determining resource for a PUSCH of a two-step CFRA procedure. In accordance with some exemplary embodiments, the method further comprises receiving the PUSCH with a preamble in one message (e.g. message A, etc.) from a terminal device in the two-step CFRA procedure, according to the determined resource.

In accordance with some exemplary embodiments, the method according to the fifth aspect of the present disclosure may further comprise: transmitting to the terminal device signaling information for message A PUSCH transmission of the two-step CFRA procedure.

According to a sixth aspect of the present disclosure, there is provided an apparatus which may be implemented as a network node. The apparatus comprises one or more processors and one or more memories comprising computer program codes. The one or more memories and the computer program codes are configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a network node. The apparatus comprises a determining unit and a receiving unit. In accordance with some exemplary embodiments, the determining unit is operable to carry out at least the determining step of the method according to the fifth aspect of the present disclosure. The receiving unit is operable to carry out at least the receiving step of the method according to the fifth aspect of the present disclosure.

In accordance with some exemplary embodiments, the resource for the PUSCH determined by the network node according to the fifth aspect of the present disclosure may correspond to the resource for the PUSCH determined by the terminal device according to the first aspect of the present disclosure. Thus, the resource for the PUSCH according to the first and fifth aspects of the present disclosure may have the same or similar contents and/or feature elements. Correspondingly, the determination of the resource for the PUSCH according to the first and fifth aspects of the present disclosure may be based on the same or similar parameter(s) and/or rule(s).

In accordance with some exemplary embodiments, the determined resource may include a PUSCH occasion.

In accordance with some exemplary embodiments, the determined resource may be indicated by one or more of:
a preamble group associated to PUSCH configuration;
a number of slots containing one or more PUSCH occasions;
a number of time domain PUSCH occasions in each slot; and
a number of PUSCH occasions frequency-division multiplexed in one time instance.

In accordance with some exemplary embodiments, the determined resource may be indicated by one or more parameters having default values.

In accordance with some exemplary embodiments, the determination of the resource for the PUSCH may be based at least in part on one or more of:
a number of PRUs corresponding to each PRACH slot; and
whether only a single PRU is valid for each PRACH slot.

In accordance with some exemplary embodiments, the determined resource may include a PRU.

In accordance with some exemplary embodiments, the determination of the resource for the PUSCH may be based at least in part on one or more of:
a number of ports per code division multiplexing (CDM) group;
indication information of one or more CDM groups; and
a scrambling identifier.

In accordance with some exemplary embodiments, the PRU may be the only PRU in one PUSCH occasion configured for the two-step CFRA procedure.

In accordance with some exemplary embodiments, the PRU may be mapped to all preambles configured for the two-step CFRA procedure in a PRACH slot.

In accordance with some exemplary embodiments, the PRU may be selected from a set of PRUs in one or more PUSCH occasions.

In accordance with some exemplary embodiments, the selection of the PRU may be based at least in part on one or more of:
an identifier of the preamble in the message;
an identifier of a synchronization signal and physical broadcast channel block (also known as an SS/PBCH block or SSB for short) which is associated with the preamble in the message;
an identifier of the PRU; and
a predetermined ordering rule (e.g. the 1st DMRS port and the 1st DMRS sequence in the 1st PUSCH occasion, etc.).

In accordance with some exemplary embodiments, the determined resource may include two or more PRUs.

In accordance with some exemplary embodiments, the two or more PRUs may be mapped to at least part of preambles which are configured for the two-step CFRA procedure in a PRACH slot, according to a first mapping ratio.

In accordance with some exemplary embodiments, the first mapping ratio may be independent of a second mapping ratio which is used for preamble to PRU mapping in another PRACH slot different from the PRACH slot.

In accordance with some exemplary embodiments, the mapping between the at least part of preambles and the two or more PRUs may be one to one mapping.

In accordance with some exemplary embodiments, the preamble in the message may be mapped to at least one of the two or more PRUs.

In accordance with some exemplary embodiments, the two-step CFRA procedure may be operated in a sharable spectrum.

In accordance with some exemplary embodiments, the two or more PRUs may be mapped to each of all preambles configured for the two-step CFRA procedure in a PRACH slot.

In accordance with some exemplary embodiments, the determined resource may be a first available PRU in a clear channel assessment (CCA) process.

In accordance with some exemplary embodiments, the determination of the resource for the PUSCH may be based at least in part on: whether each of preambles for the two-step CFRA procedure in a PRACH slot is mapped to all PRUs which are valid for the two-step CFRA procedure and associated with the PRACH slot.

In accordance with some exemplary embodiments, the determination of the resource for the PUSCH may be based at least in part on: a number of PRUs which are valid for the two-step CFRA procedure and associated with a PRACH slot.

In accordance with some exemplary embodiments, the determination of the resource for the PUSCH may be based at least in part on:
a number of PUSCH configurations available for the two-step CFRA procedure; and
which PUSCH configuration is used in the two-step CFRA procedure.

In accordance with some exemplary embodiments, the determination of the resource for the PUSCH may be based at least in part on: predetermined information for message A PUSCH transmission in the two-step CFRA procedure.

According to a ninth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the fifth aspect of the present disclosure.

According to a tenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the fifth aspect of the present disclosure.

According to an eleventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first aspect of the present disclosure.

According to a twelfth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first aspect of the present disclosure.

According to a thirteenth aspect of the present disclosure, there is provided a method implemented in a communication system which may include a host computer, a base station and a UE. The method may comprise, at the host computer, receiving user data transmitted to the base station from the UE which may perform any step of the method according to the first aspect of the present disclosure.

According to a fourteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first aspect of the present disclosure.

According to a fifteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the fifth aspect of the present disclosure.

According to a sixteenth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the fifth aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1A is a diagram illustrating an exemplary four-step RA procedure according to an embodiment of the present disclosure;

FIG. 1B is a diagram illustrating an exemplary PRACH configuration according to an embodiment of the present disclosure;

FIGS. 1C-1D are diagrams illustrating examples of an association between an SSB and a PRACH occasion according to some embodiments of the present disclosure;

FIG. 1E is a diagram illustrating an example of mapping between an SSB and RA preambles according to an embodiment of the present disclosure;

FIG. 1F is a diagram illustrating exemplary preambles per SSB per PRACH occasion according to an embodiment of the present disclosure;

FIG. 2A is a diagram illustrating an exemplary two-step RA procedure according to an embodiment of the present disclosure;

FIG. 2B is a diagram illustrating exemplary preambles per SSB per PRACH occasion according to another embodiment of the present disclosure;

FIGS. 2C-2D are diagrams illustrating exemplary CFRA procedures according to some embodiments of the present disclosure;

FIGS. 2E-2F are diagrams illustrating exemplary information elements according to some embodiments of the present disclosure;

FIG. 3A is a diagram illustrating an exemplary msgA PUSCH configuration information element according to an embodiment of the present disclosure;

FIG. 3B is a diagram illustrating an exemplary CFRA configuration information element according to an embodiment of the present disclosure;

FIG. 3C is a diagram illustrating an exemplary resource configuration for a two-step RA procedure according to an embodiment of the present disclosure;

FIG. 3D is a diagram illustrating an exemplary resource configuration for a two-step RA procedure according to another embodiment of the present disclosure;

FIG. 3E is a diagram illustrating an exemplary CFRA configuration information element according to another embodiment of the present disclosure;

FIG. 4A is a flowchart illustrating a method according to some embodiments of the present disclosure;

FIG. 4B is a flowchart illustrating another method according to some embodiments of the present disclosure;

FIG. 5 is a block diagram illustrating an apparatus according to some embodiments of the present disclosure;

FIG. 6A is a block diagram illustrating another apparatus according to some embodiments of the present disclosure;

FIG. 6B is a block diagram illustrating a further apparatus according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

According to various exemplary embodiments, the communication network may comprise a non-terrestrial network (NTN) or other suitable types of networks supported by any appropriate communication protocol.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

According to various exemplary embodiments, the network node may comprise a satellite, an unmanned aircraft system (UAS) platform or other suitable types of network devices deployed in a communication network such as NTN. It can be appreciated that the network node such as gNB in various exemplary embodiments according to the present disclosure may be implemented as or configured at a satellite or UAS platform.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. As described previously, in order to connect to a network node such as a gNB in a wireless communication network, a terminal device such as a UE may need to perform a RA procedure to exchange essential information and messages for communication link establishment with the network node.

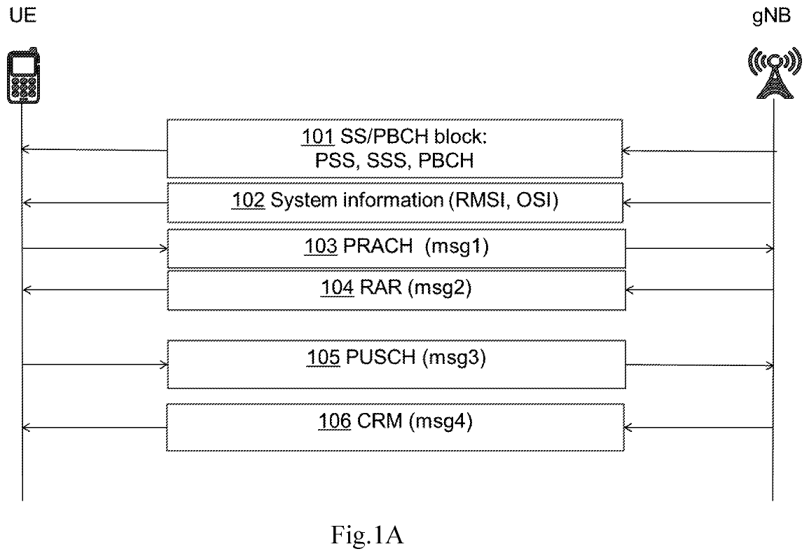

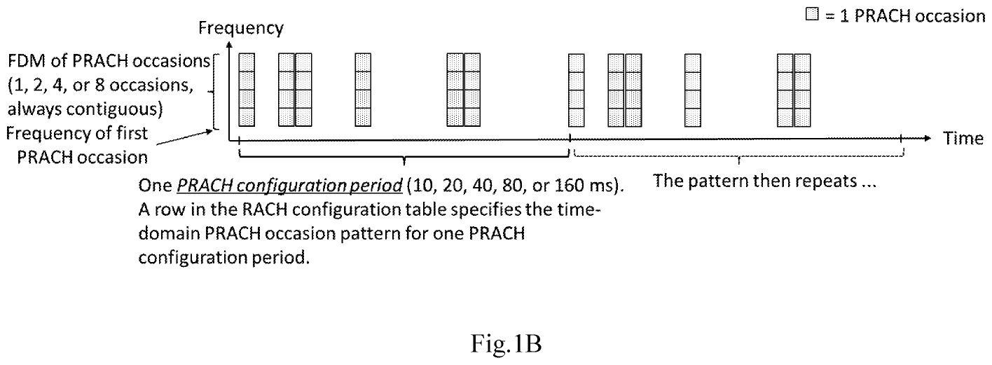

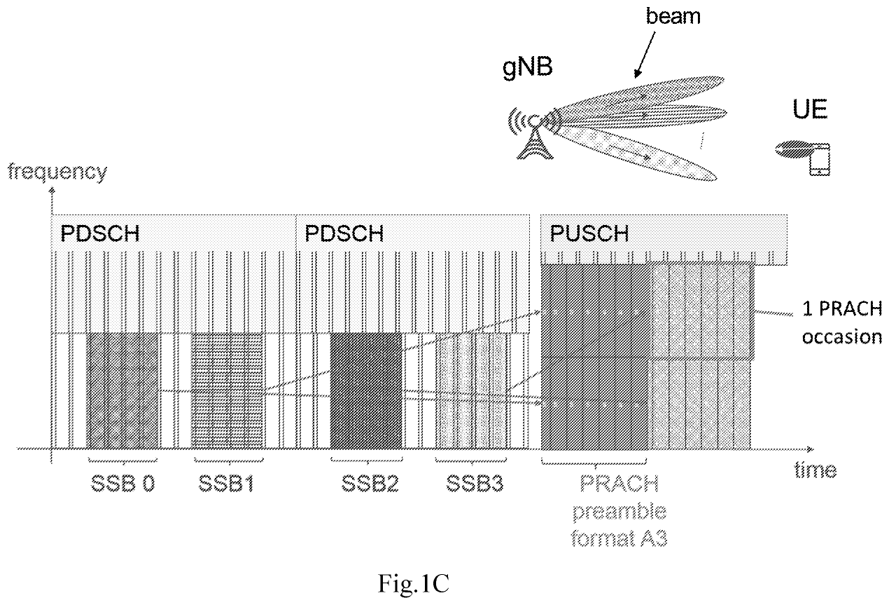

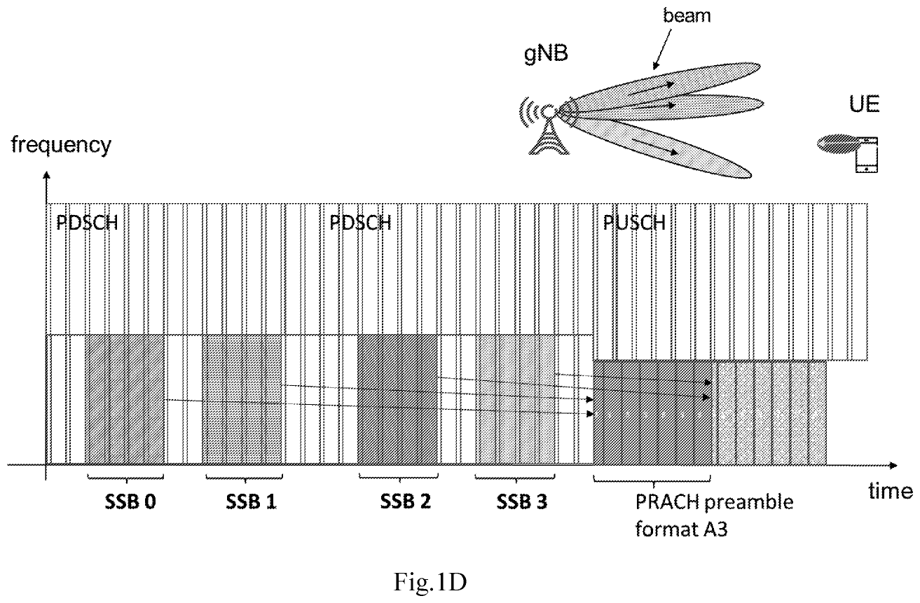

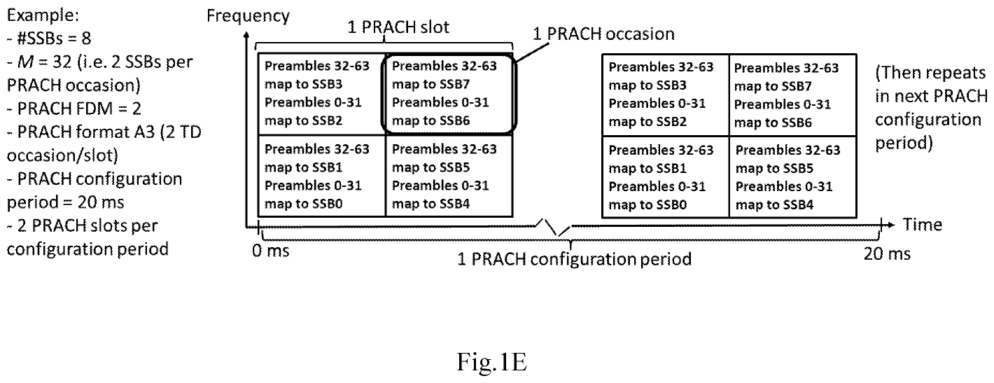

FIG. 1A is a diagram illustrating an exemplary four-step RA procedure according to an embodiment of the present disclosure. As shown in FIG. 1A, a UE can detect a synchronization signal (SS) by receiving 101 an SSB (e.g., a primary synchronization signal (PSS), a secondary synchronization signal (SSS), and physical broadcast channel (PBCH)) from a gNB in a NR system. The UE can decode 102 some system information (e.g., remaining minimum system information (RMSI) and other system information (OSI)) broadcasted in the downlink (DL). Then the UE may transmit 103 a PRACH preamble (message1/msg1) in the uplink (UL). The gNB may reply 104 with a random access response (RAR, message2/msg2). In response to the RAR, the UE may transmit 105 the UE's identification information (message3/msg3) on PUSCH. Then the gNB may send 106 a contention resolution message (CRM, message4/msg4) to the UE.

In this exemplary procedure, the UE transmits message3/msg3 on PUSCH after receiving a timing advance command in the RAR, allowing message3/msg3 on PUSCH to be received with timing accuracy within a cyclic prefix (CP). Without this timing advance, a very large CP may be needed in order to be able to demodulate and detect message3/msg3 on PUSCH, unless the communication system is applied in a cell with very small distance between the UE and the gNB. Since the NR system can also support larger cells with a need for providing a timing advance command to the UE, the four-step approach is needed for the RA procedure.

In the NR system, the time and frequency resource on which a PRACH preamble is transmitted may be defined as a PRACH occasion, which is also called RACH occasion, or RA occasion, or in short RO. In this document, the RO used for the transmission of preambles in a two-step RA procedure may be called two-step RO, and the RO used for the transmission of preambles in a four-step RA procedure may be called four-step RO.

Different PRACH configuration schemes may be specified for frequency range 1 (FR1) paired spectrum, FR1 unpaired spectrum and frequency range 2 (FR2) with unpaired spectrum, respectively. The specified PRACH configuration may be maintained in a PRACH configuration table. The time resource and preamble format for PRACH transmission may be configured by a PRACH configuration index, which indicates a row in a PRACH configuration table, e.g., as specified in 3GPP TS 38.211 V16.1.0, Tables 6.3.3.2-2, 6.3.3.2-3, 6.3.3.2-4 for FR1 paired spectrum, FR1 unpaired spectrum and FR2 with unpaired spectrum, respectively (where the entire content of this technical specification is incorporated into the present disclosure by reference). As an example, at least part of PRACH configuration for preamble format 0 for FR1 unpaired spectrum is shown in Table 1.

TABLE 1

| | | | | | | | Nₜ^{RA, slot}, | |
|---|---|---|---|---|---|---|---|---|
| | | | | | | | number of | |
| | | | | | | Number of | time-domain | |
| | | | | | | PRACH | PRACH | |
| PRACH | | | | | | slots | occasions | N_{dur}^{RA}, |
| Configuration | Preamble | n_{SFN} mod x = y | | Subframe | Starting | within a | within a | PRACH |
| Index | format | x | y | number | symbol | subframe | PRACH slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |
| 10 | 0 | 1 | 0 | 6 | 0 | — | — | 0 |
| 11 | 0 | 1 | 0 | 5 | 0 | — | — | 0 |
| 12 | 0 | 1 | 0 | 4 | 0 | — | — | 0 |
| 13 | 0 | 1 | 0 | 3 | 0 | — | — | 0 |
| 14 | 0 | 1 | 0 | 2 | 0 | — | — | 0 |
| 15 | 0 | 1 | 0 | 1, 6 | 0 | | | 0 |
| 16 | 0 | 1 | 0 | 1, 6 | 7 | — | — | 0 |
| 17 | 0 | 1 | 0 | 4, 9 | 0 | — | — | 0 |
| 18 | 0 | 1 | 0 | 3, 8 | 0 | — | — | 0 |
| 19 | 0 | 1 | 0 | 2, 7 | 0 | — | — | 0 |
| 20 | 0 | 1 | 0 | 8, 9 | 0 | — | — | 0 |
| 21 | 0 | 1 | 0 | 4, 8, 9 | 0 | — | — | 0 |
| 22 | 0 | 1 | 0 | 3, 4, 9 | 0 | — | — | 0 |
| 23 | 0 | 1 | 0 | 7, 8, 9 | 0 | — | — | 0 |
| 24 | 0 | 1 | 0 | 3, 4, 8, 9 | 0 | — | — | 0 |
| 25 | 0 | 1 | 0 | 6, 7, 8, 9 | 0 | — | — | 0 |
| 26 | 0 | 1 | 0 | 1, 4, 6, 9 | 0 | — | — | 0 |
| 27 | 0 | 1 | 0 | 1, 3, 5, 7, 9 | 0 | — | — | 0 |

In Table 1, the value of x indicates the PRACH configuration period in number of system frames, and the value of y indicates the system frame within each PRACH configuration period on which the PRACH occasions are configured. For instance, if y is set to 0, then it means that PRACH occasions are only configured in the first frame of each PRACH configuration period. The value in the column “Subframe number” tells which subframes are configured with PRACH occasions. The value in the column “Starting symbol” is the symbol index. Determination of time resources for PRACH transmission for FR2 is similar, except that 60 kHz slots are used instead of subframes.

In the case of time division duplexing (TDD), semi-statically configured DL parts and/or actually transmitted SSBs can override and invalidate some time-domain PRACH occasions defined in the PRACH configuration table. More specifically, PRACH occasions in the UL part are always valid, and a PRACH occasion within a certain part (e.g., a part with flexible symbols within a NR slot) is valid as long as it does not precede or collide with an SSB in the RACH slot and there are at least N symbols after the DL part and the last symbol of an SSB. For example, N may be set as 0 or 2, depending on the PRACH format and subcarrier spacing.

In the frequency domain, a NR system may support multiple frequency-multiplexed PRACH occasions on the same time-domain PRACH occasion. This is mainly motivated by the support of analog beam sweeping in the NR system such that the PRACH occasions associated to one SSB are configured at the same time instance but different frequency locations.

FIG. 1B is a diagram illustrating an exemplary PRACH configuration according to an embodiment of the present disclosure. As shown in FIG. 1B, the number of PRACH occasions frequency-division multiplexed (FDMed) in one time domain PRACH occasion may be 1, 2, 4, or 8, and the PRACH configuration period may be 10 ms, 20 ms, 40 ms, 80 ms or 160 ms. As mentioned previously, a row in a PRACH/RACH configuration table can specify the time-domain PRACH occasion pattern for one PRACH configuration period.

In accordance with an exemplary embodiment, there may be up to 64 sequences that can be used as RA preambles per PRACH occasion in each cell. The radio resource control (RRC) parameter such as totalNumberOfRA-Preambles can be used to determine how many of these 64 sequences are used as RA preambles per PRACH occasion in each cell. The 64 sequences may be configured by including firstly all the available cyclic shifts of a root Zadoff-Chu sequence, and secondly in the order of increasing root index, until 64 preambles have been generated for the PRACH occasion.

According to some exemplary embodiments, there may be an association between an SSB and a PRACH occasion. For example, one-to-one association between an SSB and a PRACH occasion (e.g., one SSB per PRACH occasion) may be supported in the NR system. Similarly, one-to-many and/or many-to-one association between SSB(s) and PRACH occasion(s) may also be supported in the NR system.

FIGS. 1C-1D are diagrams illustrating examples of an association between an SSB and a PRACH occasion according to some embodiments of the present disclosure. In the example of one SSB per PRACH occasion as shown in FIG. 1C, SSB0, SSB1, SSB2 and SSB3 are associated with four different PRACH occasions, respectively. In the example of two SSBs per PRACH occasion as shown in FIG. 1D, SSB0 and SSB1 are associated with a PRACH occasion, and SSB2 and SSB3 are associated with another PRACH occasion. It can be appreciated that the association between an SSB and a PRACH occasion as shown in FIG. 1C or FIG. 1D is just an example, and other suitable association between an SSB and a PRACH occasion with a proper PRACH preamble format may also be implemented.

In accordance with an exemplary embodiment, a gNB can use different transmission beams to transmit the respective SSBs to a UE. When the UE detects one best SSB beam, a preamble in the set of one or more preambles mapped to this SSB may be selected by the UE for the random access. Then the UE may send PRACH preambles to the gNB in an associated PRACH occasion. When the gNB detects the preamble, the best SSB beam for this UE may be known indirectly by the gNB, so that the best beam can be used for transmitting signals to or receiving signals from this UE. For example, according to the association between an SSB and a PRACH occasion and the mapping from an SSB to a transmission beam, the gNB can use the PRACH preambles received from the UE to determine its transmission beam preferred by the UE. Then the gNB can use the determined transmission beam in the DL transmission and optionally in the UL reception.

In accordance with some exemplary embodiments, the preambles associated to each SSB may be configured by two RRC parameters ssb-perRACH-OccasionAndCB-PreamblesPerSSB and totalNumberOfRA-Preambles, which may be indicated by an information element (IE) such as RACH-ConfigCommon in a system information block (e.g., SIB 1). A specific rule may be defined for mapping an SSB to RA preambles, as described in section 8.1 of 3GPP TS 38.213 V16.1.0. For example, a UE may be provided with a number N of SSBs associated with one PRACH occasion and a number R of contention-based (CB) preambles per SSB per valid PRACH occasion by parameter ssb-perRACH-OccasionAndCB-PreamblesPerSSB. If N<1, one SSB is mapped to 1/N consecutive valid PRACH occasions and R contention-based preambles with consecutive indexes associated with the SSB per valid PRACH occasion start from preamble index 0. If N≥1, R contention-based preambles with consecutive indexes associated with SSB n, 0≤n≤N−1, per valid PRACH occasion start from preamble index n·N_{preamble}^{total}/N, where N_{preamble}^{total} is provided by parameter totalNumberOfRA-Preambles and is an integer multiple of N.

FIG. 1E is a diagram illustrating an example of mapping between an SSB and RA preambles according to an embodiment of the present disclosure. In this example, the number of PRACH slots in one PRACH configuration period is 2, the number of PRACH occasions in one PRACH slot is 4, and the number of SSBs in one PRACH occasion is 2. As shown in FIG. 1E, the mapping between an SSB and PRACH preambles may be done by consecutively associating M preambles to each SSB, where M=N_{preamble}^{total}/N. For instance, the preambles can be taken as follows:
First, in increasing order of preamble indexes within a single PRACH occasion;
Second, in increasing order of frequency resource indexes for frequency multiplexed PRACH occasions; and
Third, in increasing order of time.

FIG. 1F is a diagram illustrating exemplary preambles per SSB per PRACH occasion according to an embodiment of the present disclosure. In this embodiment, for each SSB, the associated preambles per PRACH occasion are further divided into two sets for contention-based random access (CBRA) and contention free random access (CFRA). The number of contention-based (CB) preambles per SSB per PRACH occasion may be signaled by an RRC parameter such as #CB-preambles-per-SSB. Preamble indices for CBRA and CFRA are mapped consecutively for one SSB in one PRACH occasion, as shown in FIG. 1F.

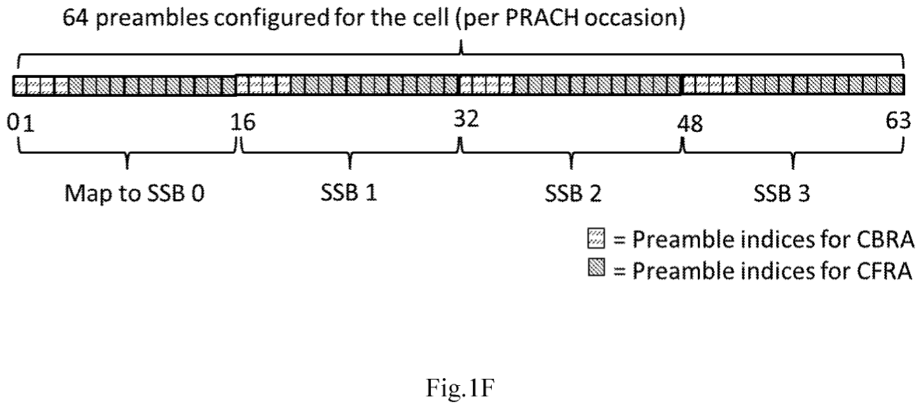

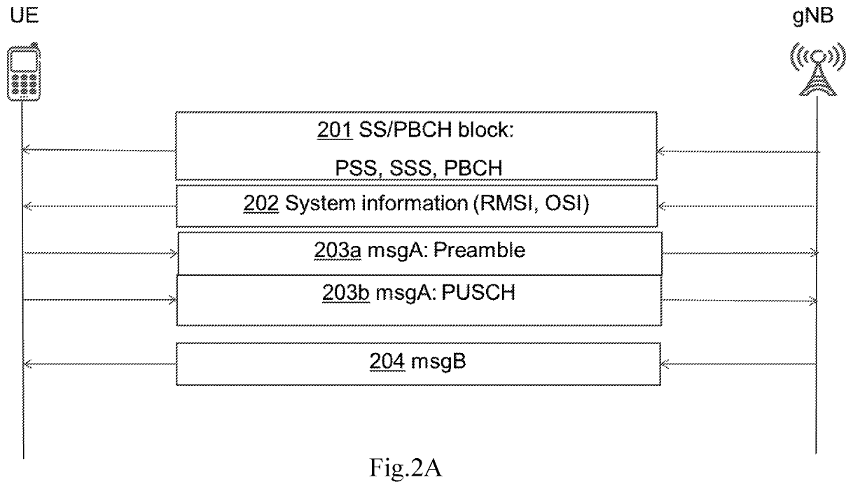

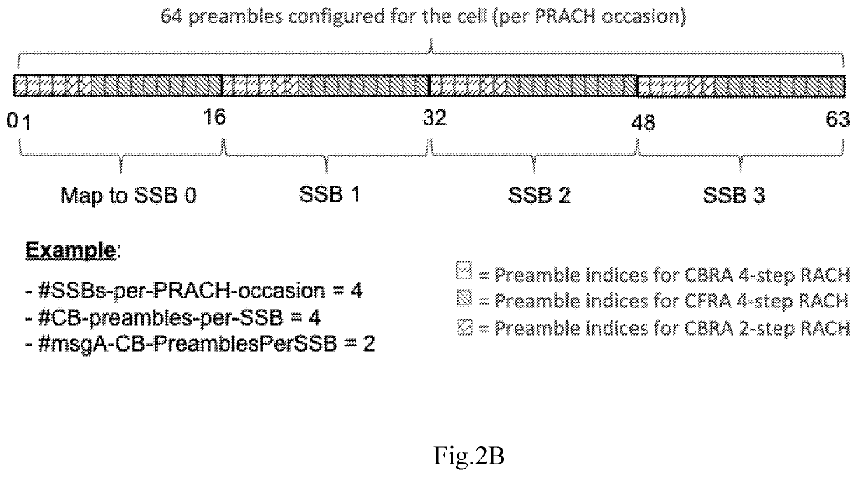

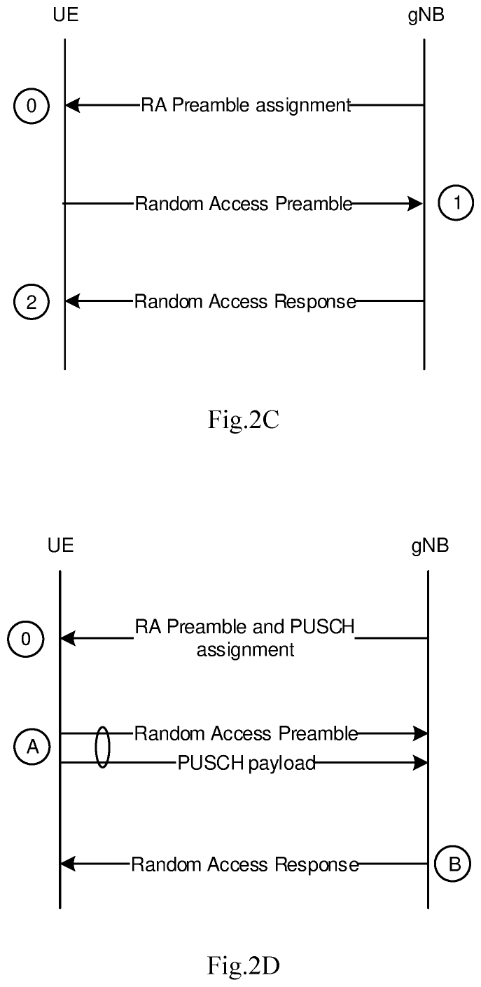

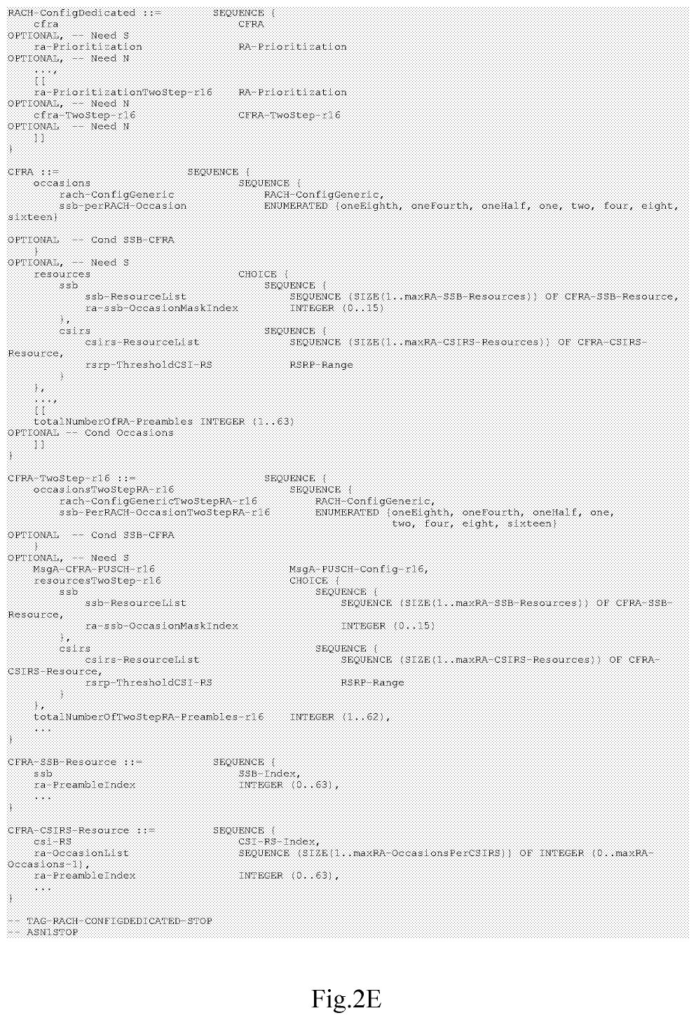

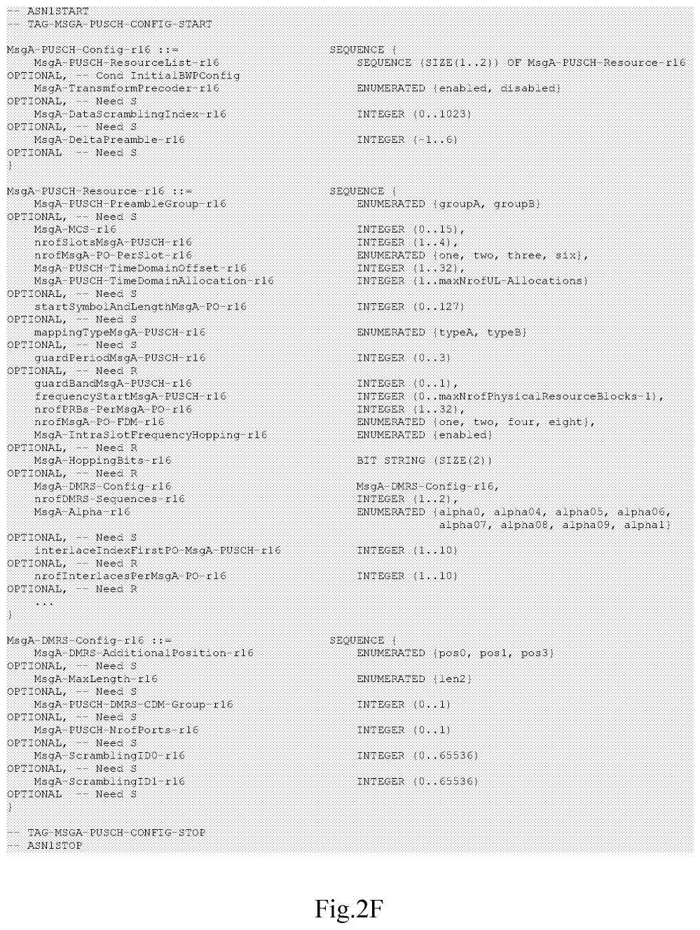

FIG. 2A is a diagram illustrating an exemplary two-step RA procedure according to an embodiment of the present disclosure. Similar to the procedure as shown in FIG. 1A, in the procedure shown in FIG. 2A, a UE can detect a SS by receiving 201 an SSB (e.g., comprising a PSS, a SSS and PBCH) from a gNB in a NR system, and decode 202 system information (e.g., remaining minimum system information (RMSI) and other system information (OSI)) broadcasted in the DL. Compared to the four-step approach as shown in FIG. 1A, the UE performing the procedure in FIG. 2A can complete random access in only two steps. Firstly, the UE sends 203a/203b to the gNB a message A (abbreviated “MsgA” or “msgA”, where these two abbreviations may be used interchangeably in this document) including RA preamble together with higher layer data such as an RRC connection request possibly with some payload on PUSCH. Secondly, the gNB sends 204 to the UE a RAR (also called message B or abbreviated “MsgB” or “msgB”, where these two abbreviations may be used interchangeably in this document) including UE identifier assignment, timing advance information, a contention resolution message, and etc. It can be seen that there may be no explicit grant from msgB for PUSCH in msgA as the msgB is after msgA.

In the two-step RA procedure, the preamble and msgA PUSCH can be transmitted by the UE in one message called message A. Separate PRACH resources (defined by ROs and preamble sequences) can be configured for the two-step RA procedure and the four-step RA procedure so that the network can distinguish the UEs performing the four-step RA procedure from the UEs performing the two-step RA procedure.

In accordance with some exemplary embodiments, the RACH occasions for two-step RA may be either separately configured (also known as Type-2 random access procedure with separate configuration of PRACH occasions with Type-1 random access procedure) or are shared with four-step RA (also known as Type-2 random access procedure with common configuration of PRACH occasions with Type-1 random access procedure) in which case different sets of preamble IDs may be used, as described in section 8.1 of 3GPP TS 38.213 V16.1.0.

For Type-2 random access procedure with common configuration of PRACH occasions with Type-1 random access procedure, a UE is provided a number N of SS/PBCH blocks associated with one PRACH occasion by ssb-perRACH-OccasionAndCB-PreamblesPerSSB and a number Q of contention based preambles per SS/PBCH block per valid PRACH occasion by MsgA-CB-PreamblesPerSSB. The PRACH transmission can be on a subset of PRACH occasions associated with a same SS/PBCH block index for a UE provided with a PRACH mask index by MsgA-ssb-sharedRO-MaskIndex.

FIG. 2B is a diagram illustrating exemplary preambles per SSB per PRACH occasion according to another embodiment of the present disclosure. In this embodiment, ROs for two-step RACH and four-step RACH are shared. As shown in FIG. 2B, the number of SSBs in one PRACH occasion is 4, and for each SSB, the associated preambles per SSB per PRACH occasion are further divided into three sets, including 4 preambles for CBRA four-step RACH, 10 preambles for CFRA four-step RACH, and 2 preambles for CBRA two-step RACH. It can be appreciated that only one preamble group is assumed in this example, the SSB to RO mapping and the preamble allocation shown in FIG. 2B is just an example, and other suitable association between an SSB and a PRACH occasion with a proper PRACH preamble allocation may also be implemented.

For Type-2 random access procedure with separate configuration of PRACH occasions with Type-1 random access procedure, a UE is provided a number N of SS/PBCH blocks associated with one PRACH occasion and a number R of contention based preambles per SS/PBCH block per valid PRACH occasion by ssb-perRACH-OccasionAndCB-PreamblesPerSSB-MsgA when provided; otherwise, by ssb-perRACH-OccasionAndCB-PreamblesPerSSB. Since the SSB to RO mapping and the preamble allocation are independently configured, the example provided for four-step RACH as shown in FIG. 1F may also be valid for this case of two-step RACH except that the parameters are separately configured for two-step RACH.

In accordance with some exemplary embodiments, a PUSCH occasion (PO) may be defined as the time frequency resource used for one PUSCH transmission. For one msgA PUSCH occasion, one or more DMRS resources can be configured, one of which may be selected for each PUSCH transmission within the PUSCH occasion. The term “PUSCH resource unit (PRU)” used in this document may refer to a PUSCH occasion with one DMRS resource.

A set of PUSCH occasions may be configured per msgA PUSCH configuration which is relative to and mapped by a group of preambles in a set of ROs in one PRACH slot. As described in section 8.1A of 3GPP TS 38.213 V16.1.0, the mapping between one or more PRACH preambles and a PUSCH occasion associated with a DMRS resource may be according to the mapping order (also called mapping scheme I in this document) as below.
Each consecutive number of N_{preamble} preamble indexes from valid PRACH occasions in a PRACH slot
   first, in increasing order of preamble indexes within a single PRACH occasion;
   second, in increasing order of frequency resource indexes for frequency multiplexed PRACH occasions;
   third, in increasing order of time resource indexes for time multiplexed PRACH occasions within a PRACH slot;
      are mapped to a valid PUSCH occasion and the associated DMRS resource
first, in increasing order of frequency resource indexes f_{id} for frequency multiplexed PUSCH occasions;
second, in increasing order of DMRS resource indexes within a PUSCH occasion, where a DMRS resource index DMRS_{id} is determined first in an ascending order of a DMRS port index and second in an ascending order of a DMRS sequence index (e.g. as described in 3GPP TS 38.211 V16.1.0);
third, in increasing order of time resource indexes t_{id} for time multiplexed PUSCH occasions within a PUSCH slot;
fourth, in increasing order of indexes for Nₛ PUSCH slots;
   where N_{preamble}=ceil(T_{preamble}/T_{PUSCH}), T_{preamble} is a total number of valid PRACH occasions per association pattern period multiplied by the number of preambles per valid PRACH occasion provided by MsgA-PUSCH-PreambleGroup, and T_{PUSCH} is a total number of valid PUSCH occasions per PUSCH configuration per association pattern period multiplied by the number of DMRS resource indexes per valid PUSCH occasion provided by MsgA-DMRS-Config.

In accordance with some exemplary embodiments, a RA procedure such as two-step RACH and four-step RACH can be performed in two different ways, e.g., contention-based (CBRA) and contention-free (CFRA). The difference is in that which preamble is used. In the contention-based case, a UE may randomly select a preamble from a range of preambles. For this case, there may be a collision if two UEs select the same preamble. In the contention-free case, a UE may be given a specific preamble by the network, which ensures that two UEs will not select the same preamble, thus the RA is collision-free. The CBRA may be typically used when a UE is in an idle/inactive state and wants to go to the connected state, while the CFRA may be used for performing handover and/or in beam failure procedures.

FIGS. 2C-2D are diagrams illustrating exemplary CFRA procedures according to some embodiments of the present disclosure. In the exemplary CFRA procedure, the network may assign a preamble for CFRA in four-step RACH or a preamble and PUSCH for CFRA in two-step RACH. The network may not configure CFRA resources for four-step and two-step RA types at the same time for a Bandwidth Part (BWP). In an embodiment, CFRA with two-step RA type may be only supported for handover.

In a four-step CFRA procedure (also called CFRA with four-step RA type) as shown in FIG. 2C, a UE may receive a RA preamble assignment from a gNB in step 0, prior to transmitting msg1 (including a RA preamble) to the gNB in step 1 and receiving a RAR from the gNB in step 2. In a two-step CFRA procedure (also called CFRA with two-step RA type) as shown in FIG. 2D, a UE may receive a RA preamble and PUSCH assignment from a gNB in step 0, prior to transmitting msgA (including RA preamble and PUSCH payload) to the gNB in step A and receiving msgB (RAR) from the gNB in step B. As shown in FIGS. 2C-2D, the msg1 of four-step RA type may include only a preamble on PRACH, while the msgA of the two-step RA type may include a preamble on PRACH and a payload on PUSCH. After msg1 transmission or msgA transmission, the UE may monitor for a response from the network within a configured window. For CFRA, upon receiving the network response, the UE may end the random access procedure.

FIGS. 2E-2F are diagrams illustrating exemplary information elements (IEs) according to some embodiments of the present disclosure. FIG. 2E shows an exemplary RACH-ConfigDedicated IE for CFRA with two-step RA type, and FIG. 2F shows an exemplary MsgA-PUSCH-Config-r16 IE for CFRA with two-step RA type. In accordance with some exemplary embodiments, the RACH configuration and the msgA PUSCH configuration for CFRA with two-step RA type may be similar to the RACH configuration and the msgA PUSCH configuration for CBRA with two-step RA type. As an example, for CFRA with two-step RA type, a parameter MsgA-CFRA-PUSCH similar to what is used for CBRA with two-step RA type may be included in the RACH-ConfigDedicated IE.

In some application cases, the msgA PUSCH configuration for CFRA with two-step RA type is simply a copy of the definitions of sets of msgA PUSCH configurations for the CBRA with two-step RA type, which may provide multiple sets of PRUs. This means a preamble to PRU mapping may be needed to determine which PRU is used for CFRA with two-step RA type.

Various exemplary embodiments of the present disclosure propose a solution for RA, which can enable radio resource (e.g. one or more PRUs) to be determined for the CFRA with two-step RA type, for example, according to different resource configuration and application scenarios (e.g., the number of PRUs needed). According to the proposed solution, the adaptive association between various transmission resources/signaling, e.g. SSB to preamble and RO mapping, and the mapping between preamble(s) in one RO and the associated PRU(s), may be implemented for CFRA with two-step RA type flexibly. In this way, the CFRA with two-step RA type may be performed with enhanced resource utilization and improved transmission efficiency and flexibility.

According to the typical two-step CBRA configuration, multiple PRUs (where a PRU is a PO with a DMRS resource) may be configured for each PRACH slot. This may be suboptimal for CFRA with two-step RA type. In some cases, when the CFRA with two-step RA type is used with dedicated msgA PUSCH resources (i.e. which cannot be used by any other UE), a single PRU may be enough per PRACH slot. The reasons may include:
that the PRU is dedicated for the concerned UE and thus multiple PRUs, for instance mapping to different preambles, may not be needed; and
that the PRU is needed only as a predefined UL transmission resource which does not implicitly signal anything to a gNB, because the selected SSB is indicated by the used PRACH occasion and, in the case that multiple SSBs map to the same PRACH occasion, the CFRA preamble.

It can be realized that the problem of suboptimal PRU configuration (i.e. multiple PRUs configured per PRACH slot) for the CFRA with two-step RA type may arise when multiple preambles are configured for the same PRACH slot and that may be necessary only when multiple preambles are configured for the same PRACH occasion, because multiple SSBs map to the same PRACH occasion and different preambles have to be configured to indicate the selected SSB (out of the set of SSBs mapping to the same PRACH occasion) to the gNB. That the suboptimal PRU configuration is a resulting consequence may be clear from the content (e.g., mapping scheme I mentioned previously) of mapping between PRACH preamble(s) and a PO associated with a DMRS resource as described in section 8.1A of 3GPP TS 38.213 V16.1.0.

In accordance with some exemplary embodiments, a single PUSCH occasion may be determined for CFRA with two-step RA type, for example, via determining one or more of the following parameters:
the preamble group that the PUSCH configuration associated to;
the number of slots (in active UL BWP numerology) containing one or multiple PUSCH occasions;
the number of time domain PUSCH occasions in each slot; and
the number of msgA PUSCH occasions FDMed in one time instance.

In an embodiment where a single CFRA preamble is configured, some configuration IEs/parameters as described in 3GPP TS 38.331 V15.9.0 (where the entire content of this technical specification is incorporated into the present disclosure by reference) may be set in a way that results in only a single PUSCH occasion to be configured per PRACH slot. This may be achieved by setting some parameters of MsgA-CFRA-PUSCH-r16/MsgA-PUSCH-Config-r16 suitably when being a part of the RACH-ConfigDedicated IE. It is noted that MsgA-PUSCH-Config-r16 is the name of the ASN.1 parameter/IE type and MsgA-CFRA-PUSCH-r16 is the name of a parameter/IE of that type included in the RACH-ConfigDedicated IE.

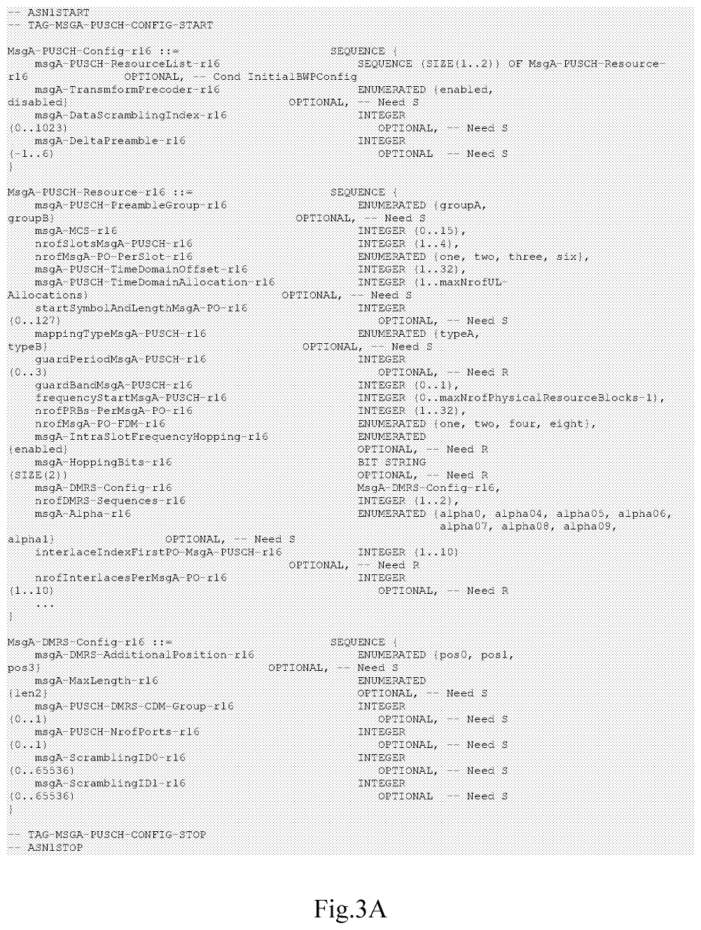

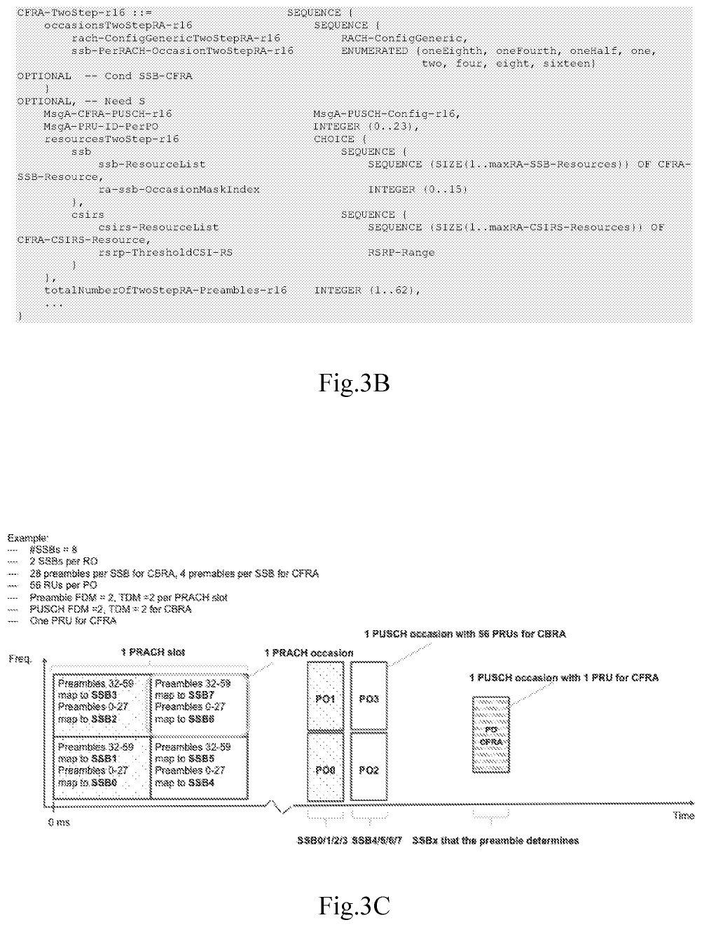

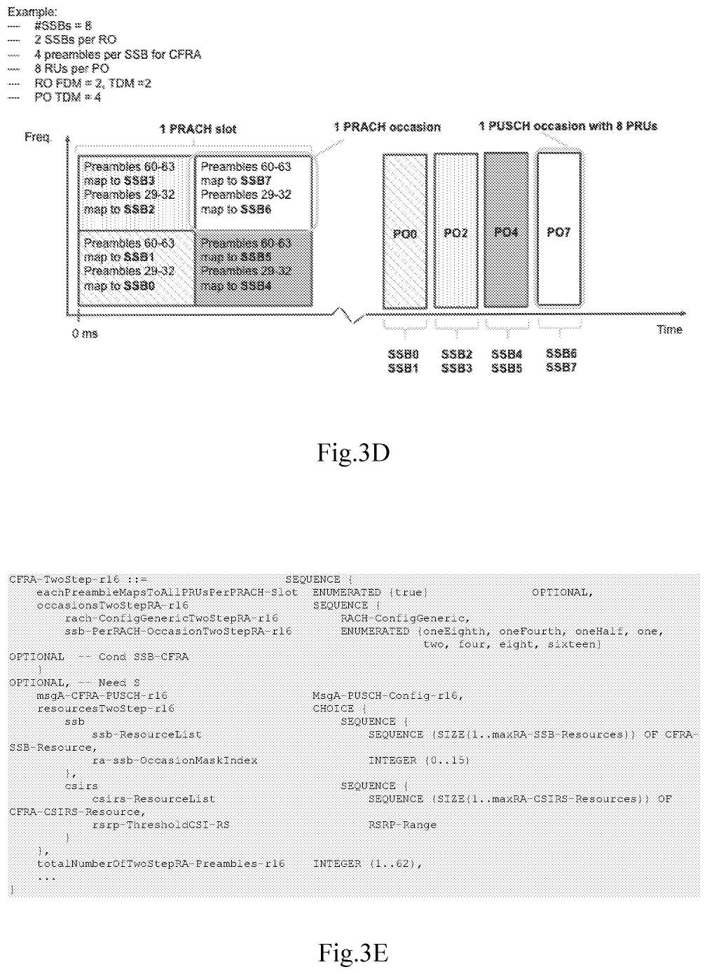

FIG. 3A is a diagram illustrating an exemplary msgA PUSCH configuration information element according to an embodiment of the present disclosure. In the exemplary MsgA-PUSCH-Config IE shown in FIG. 3A, a parameter msgA-PUSCH-PreambleGroup-r16 may be used to indicate the preamble group to which the PUSCH configuration is associated, a parameter nrofSlotsMsgA-PUSCH-r16 may be used to indicate the number of slots (in active UL BWP numerology) containing one or more PUSCH occasions, a parameter nrofMsgA-PO-PerSlot-r16 may be used to indicate the number of time domain PUSCH occasions in each slot, and a parameter nrofMsgA-PO-FDM-r16 may be used to indicate the number of msgA PUSCH occasions FDMed in one time instance.

In accordance with some exemplary embodiments, a possible way to achieve the desired single PRU per PRACH slot configuration in the RRC specification 3GPP TS 38.331 V15.9.0 is to set the parameters of the MsgA-CFRA-PUSCH-r16/MsgA-PUSCH-Config-r16 IE in a suitable way. In an embodiment, one or more of the following parameters may be predetermined or hardcoded for CFRA with two-step RA type:
msgA-PUSCH-PreambleGroup-r16 may be set to “groupA” or this parameter may be omitted;
nrofSlotsMsgA-PUSCH-r16 may be set to 1;
nrofMsgA-PO-PerSlot-r16 may be set to “one”; and
nrofMsgA-PO-FDM-r16 may be set to “one”.

In accordance with some exemplary embodiments, the above four parameters/IEs may be made optional, and it may be specified that absence of any or all of the parameters may for the respective parameter(s) mean that values “groupA”, 1, “one” and/or “one” may be assumed.

In accordance with some exemplary embodiments, one or more of the following parameter(s)/IE(s) may be introduced or added to the MsgA-CFRA-PUSCH-r161MsgA-PUSCH-Config-r16 IE:
a first parameter indicating the number of PRUs corresponding to each PRACH slot, e.g. a parameter denoted nrofPRUsPerPRACH-Slot. In the case of two-step CFRA, the parameter may be set to 1 (if the parameter is of type INTEGER) or “one” (if the parameter is of type ENUMERATED);
a second parameter indicating whether only a single PRU may be considered valid/configured for each PRACH slot, e.g. a parameter denoted singlePRU-PerPRACH-Slot. The parameter may be of type Boolean and thus have the value “true” or “false”. In an embodiment, the parameter may be an optional parameter of type ENUMERATED with the single possible value “true”.

In accordance with some exemplary embodiments, a PRU may be determined for two-step CFRA from a set of PRUs in one or more PUSCH occasions, e.g., according to one or more of the following approaches:
a specific SSB index;
a specific preamble index;
a fixed PRU selection; and
an explicit indication by signaling.

According to an exemplary embodiment, the PRU may be determined by the SSB index selected. For the case of a single PUSCH occasion, the PRUs in this PUSCH occasion may be numbered and ordered with DMRS port firstly and DMRS sequence secondly, and the PRU ID used may be determined according to the following formula:

PRU_{ID}=mod(SSB_{IDX},N_{MAX_PRU_single}) (1)

where SSB_{IDX} is the SSB index selected to determine the PRACH resource for msgA preamble transmission, and N_{MAX_PRU_single} is the maximum number of PRUs configured in the PUSCH occasion.

For the case of multiple PUSCH occasions, the PRUs in all PUSCH occasions may be numbered and ordered in a way as described for the preamble to PRU mapping in CBRA, and the PRU ID used may be determined according to the following formula:

PRU_{ID}=mod(SSBₘₓ,N_{MAX_PRU_multiple}) (2)

where SSB_{IDX} is the SSB index selected to determine the PRACH resource for msgA preamble transmission, and N_{MAX_PRU_multiple} is the maximum total number of PRUs in all PUSCH occasions.

According to another exemplary embodiment, the PRU may be determined by the preamble index selected. For the case of a single PUSCH occasion, the PRUs in this PUSCH occasion may be numbered and ordered with DMRS port firstly and DMRS sequence secondly, and the PRU ID used may be determined according to the following formula:

PRU_{ID}=mod(Preambleₘ,N_{MAX_PRU_single}) (3)

where Preamble_{ID} is the preamble ID selected for msgA preamble transmission, and N_{MAX_PRU_single} is the maximum number of PRUs configured in the PUSCH occasion.

For the case of multiple PUSCH occasions, the PRUs in all PUSCH occasions may be numbered and ordered in a way as described for the preamble to PRU mapping in CBRA, and the PRU ID used may be determined according to the following formula:

PRU_{ID}=mod(Preamble_{ID},N_{MAX_PRU_multiple}) (4)

where Preamble_{ID} is the preamble ID selected for the msgA preamble transmission, and N_{MAX_PRU_multiple} is the maximum total number of PRUs in all PUSCH occasions.

According to another exemplary embodiment, the PRU may be fixed to be one of the PRUs in one of PUSCH occasion(s). For the case of a single PUSCH occasion, the 1st DMRS port and the 1st DMRS sequence may be always assumed as the PRU used for the two-step CFRA. For the case of multiple PUSCH occasions, the 1st DMRS port and the 1st DMRS sequence may be always assumed and the 1st PUSCH occasion may be used, where the 1st PUSCH occasion may be the earliest in time and on the lowest frequency. It can be appreciated that other PRU with different DMRS port and/or DMRS sequence in other suitable PUSCH occasion may also be determined for the two-step CFRA.

According to another exemplary embodiment, the PRU may be determined by explicit signaling. For the case of a single PUSCH occasion, a parameter MsgA-PRU-ID-PerPO may be defined in CFRA-TwoStep IE in RACH-ConfigDedicated to indicate which PRU may be used for the two-step CFRA, where the value range of the parameter MsgA-PRU-ID-PerPO may be dependent on the number of PRUs (e.g. 24 PRUs, considering maximum 2 DMRS sequences and 12 DMRS ports to be used for each PUSCH occasion).

FIG. 3B is a diagram illustrating an exemplary CFRA configuration information element according to an embodiment of the present disclosure. In the exemplary CFRA-TwoStep-r16 IE shown in FIG. 3B, the parameter MsgA-PRU-ID-PerPO may be used to indicate the PRU selected for the two-step CFRA. As an example, the parameter MsgA-PRU-ID-PerPO is of type INTEGER with a value ranging from 0 to 23.

For the case of multiple PUSCH occasions, a parameter MsgA-PRU-ID may be defined in CFRA-TwoStep IE in RACH-ConfigDedicated to indicate which PRU may be used for the two-step CFRA, where the value range of the parameter MsgA-PRU-ID may be dependent on the number of PRUs (e.g., 24 multiplied by the number of PUSCH occasions, considering maximum 2 DMRS sequences and 12 DMRS ports to be used for each PUSCH occasion).

It can be appreciated that the embodiments for multiple PUSCH occasions as described above may also be applicable for determining one PRU for CFRA from a set of PRUs in a single PUSCH occasion, which can be considered as a special case of the more general case of multiple PUSCH occasions.

FIG. 3C is a diagram illustrating an exemplary resource configuration for a two-step RA procedure according to an embodiment of the present disclosure. In the exemplary resource configuration shown in FIG. 3C, 4 POs (i.e. PO1˜PO4) with 56 RUs defined for each PO are configured for CBRA, 8 SSBs (i.e. SSB0-SSB7) are transmitted in one cell, 4 ROs are time-frequency multiplexed in one PRACH slot, 2 SSBs are mapped to each RO, 28 CBRA preambles are mapped to one SSB in one RO, and the other 4 preambles for this SSB in this RO are mapped to the PO for CFRA. In an embodiment, one PRU may be configured for CFRA per PRACH slot. In the case that 4 DMRS ports and one DMRS sequence is configured for CFRA, which means that 4 PRUs are configured in the PO for CFRA, one PRU may be determined for CFRA, for example, according to an SSB index, a preamble index, a fixed PRU selection, explicit signaling, etc.

For the cases where multiple SSBs are mapped to the same PRACH occasion, and multiple different CFRA preambles (in number equal to the number of SSBs mapping to a single PRACH occasion) may need to be configured in a PRACH slot, modifications of, and/or additions to, the current standard specification(s) may be needed. In an embodiment, a set of preambles on a set of PRACH occasions in a PRACH slot may be mapped to one PRU to be selected for CFRA automatically based on a predetermined rule. In the case that multiple PRUs are configured, a single PRU may be determined for CFRA according to the predetermined rule.

In accordance with some exemplary embodiment, the predetermined rule may indicate the preamble to PRU mapping for a contention-free Type-2 random access procedure and optionally for a contention-based Type-2 random access procedure. For example, mapping scheme I mentioned previously may be applied for the preamble to PRU mapping of the contention-based Type-2 random access procedure, as described in section 8.1A of 3GPP TS 38.213 V16.1.0. For the contention-free Type-2 random access procedure, in an embodiment, if multiple valid PUSCH occasions and associated DMRS resources are configured for a PRACH slot, all of the preamble(s) may be mapped to one PRU (e.g. the first one of the multiple PRUs), for example, according to the mapping order for contention-based Type-2 random access procedure. In this case, all preamble indexes configured for a PRACH slot may be mapped to the same valid PUSCH occasion and the associated DMRS resource (also called mapping scheme II).

In accordance with some exemplary embodiment, only one PRU in one PUSCH occasion may be configure for two-step CFRA. This may be implemented by predetermining or hardcoding one or more of the following parameters:
the number of ports per code division multiplexing (CDM) group, which may always be 1 port per CDM group;
indication information of CDM group(s), which may always indicate CDM group 0; and
a scrambling ID for UL DMRS scrambling initialization for cyclic prefix-orthogonal frequency division multiplexing (CP-OFDM), which may always use the value indicated by msgA-ScramblingID0, i.e. discard msgA-ScramblingID1.

Table 2 lists some exemplary parameters which may be included in the field MsgA-DMRS-Config as below.

TABLE 2
MsgA-DMRS-Config field descriptions

msgA-DMRS-AdditionalPosition
Indicates the position for additional DM-RS. If the field is absent, the UE
applies value pos2.
msgA-MaxLength
indicates single-symbol or double-symbol DMRS. If the field is absent, the
UE applies value len1.
msgA-PUSCH-DMRS-CDM-group
1-bit indication of indices of CDM group(s). If the field is absent, then
both CDM group are used.
msgA-PUSCH-NrofPort
0 indicates 1 port per CDM group, 1 indicates 2 ports per CDM group. If
the field is absent then 4 ports per CDM group are used.
msgA-ScramblingID0
UL DMRS scrambling initialization for CP-OFDM. If the field is absent
the UE applies the value Physical cell ID (physCellID).
msgA-ScramblingID1
UL DMRS scrambling initialization for CP-OFDM. If the field is absent
the UE applies the value Physical cell ID (physCellID).

In accordance with some exemplary embodiment, for a contention-based Type-2 random access procedure, the preamble to PRU mapping may be performed according to mapping scheme I, as described in section 8.1A of 3GPP TS 38.213 V16.1.0. For a contention-free Type-2 random access procedure, a UE may assume that only a single PRU is used per PRACH slot via assuming that a single DMRS sequence provided by the parameter msgA-ScramblingID0 is used, only one msgA-PUSCH-Resource is carried in msgA-PUSCH-ResourceList, the values of msgA-PUSCH-NrofPort, nrofSlotsMsgA-PUSCH, nrofMsgA-PO-PerSlot, nrofMsgA-PO-FDM, and nrofDMRS-Sequences are equal to one, and msgA-PUSCH-DMRS-CDM-group is equal to 0.

In accordance with some exemplary embodiment, multiple PRUs may be allowed for the msgA PUSCH transmission in the case of CFRA. In this case, a mapping between a preamble and a PRU may be implemented by various approaches. According to an embodiment, the mapping between CFRA preambles per PRACH slot and the corresponding CFRA PRUs (also called mapping scheme III) may be performed with a mapping ratio calculated by the following formula:

N_{preambleCFRA}=ceil(T_{preambleCFRA}/T_{PUSCHCFRA}) (5)

where T_{preambleCFRA} is the total number of preambles per PRACH slot for CFRA, and T_{PUSCHCFRA} is the total number of valid PRUs in the set of POs defined relative to the PRACH slot, and N_{preambleCFRA} is the number of CFRA preambles mapping to each valid PRU in the set of POs defined relative to the PRACH slot. The mapping between preambles and PRUs may be one to one mapping, one to multiple mapping, or multiple to one mapping. In an embodiment, N_{preambleCFRA} may be used to indicate the mapping ratio of the preamble to PRU mapping for a PRACH slot. Different PRACH slots may have mapping ratios that are related to each other or independent of each other.

In accordance with some exemplary embodiment, a mapping order for preamble to PRU mapping for CFRA may be the same as that used for CBRA (e.g., according to mapping scheme I). In an embodiment, one to multiple mapping between preambles and PRUs may not be supported to avoid blind decoding of msgA PUSCH. In another embodiment, one to one mapping may be always assumed between CFRA preambles and CFRA PUSCH resources, i.e. PRUs. In the case that the resources are imbalanced between preamble side and PUSCH side, one to one mapping between preambles and PRUs for CFRA may be implemented by discarding the preambles or PRUs remained (e.g., for superfluous PRUs, this is similar to what is done for imbalanced CBRA preamble to PRU mapping). In an embodiment, the balanced number of CFRA preambles and number of PRUs may be always configured to make sure of one to one mapping.

FIG. 3D is a diagram illustrating an exemplary resource configuration for a two-step RA procedure according to another embodiment of the present disclosure. In the exemplary resource configuration shown in FIG. 3D, 4 POs (i.e. PO0, PO2, PO4 and PO7) with 8 PRUs defined for each PO are configured for CFRA, 8 SSBs (i.e. SSB0-SSB7) are transmitted in one cell and 4 ROs are time-frequency multiplexed in one PRACH slot, 28 CBRA preambles are mapped to one SSB in one RO, the other 4 preambles for this SSB in this RO are mapped to the PO for CFRA. In an embodiment, multiple POs and multiple PRUs may be configured for CFRA per PRACH slot. In the case that 8 DMRS ports and one DMRS sequence in a PO are configured for CFRA, which means 8 PRUs are configured in this PO, one of the PRUs may be determined for CFRA, for example, according to an SSB index, a preamble index, a fixed PRU selection, explicit signaling, etc.

In some cases, only a single PRU may be needed for two-step CFRA per PRACH slot, since only a single UE may use this PRU (according to dedicated signaling of the CFRA configuration) and the selected SSB (or channel state information-reference signal (CSI-RS)) is indicated by the RO, the CFRA preamble or the combination of the RO and the CFRA preamble. However, this is applicable for NR operation in licensed spectrum and the circumstances may be different when an NR system is operated in unlicensed/shared spectrum (NR-U), which may motivate that multiple CFRA PRUs per PRACH slot may be useful in NR-U.

The listen-before-talk (LBT) principle may be applied for NR-U, which requires a device/transmitter to perform a clear channel assessment (CCA) operation (also referred to as an LBT operation) before transmitting on the channel in unlicensed/shared spectrum. CCA operations may be performed separately on different parts of the spectrum, e.g. different parts of the carrier bandwidth. For example, a CCA operation may concern a chunk of spectrum with 20 MHz bandwidth. This may be leveraged by frequency-multiplexed (FDMed) POs/PRUs, while time-multiplexed (TDMed) POs/PRUs may leverage that the outcome of consecutive CCA operations in the same bandwidth chunk may vary with time, depending on the channel occupancy. Hence, in order to increase the chances for a UE to find a PO/PRU for which a CCA operation is successful and in which the UE therefore can transmit its msgA PUSCH, multiple FDMed and/or TDMed POs/PRUs can be configured for CFRA for the same PRACH slot.

An exemplary two-step RACH configuration in NR-U is that a PRACH occasion ends at the end of the PRACH slot and the associated PO/PRU follows immediately after (with maximum 16 μs gap in between). This allows the UE to transmit both the preamble and msgA PUSCH after a single successful CCA operation. In such a case, FDMed pairs of CFRA RO+PO/PRU may be configured in different LBT/CCA bandwidth chunks for the same PRACH slot. The UE can simultaneously perform separate CCA operations for each of the concerned bandwidth chunks and if the CCA operation is successful (i.e. indicating a clear, unoccupied channel) in at least one of the bandwidth chunks, the UE can go ahead and transmit both preamble and msgA PUSCH using the PRACH occasion and PO/PRU in the concerned bandwidth chunk.

However, configuring a PRACH occasion and the associated PO/PRU with such small or non-existing gap may not always be possible. For instance, in order to achieve greater two-step RA capacity or to increase the chances of successful CCA prior to a PRACH occasion, TDMed PRACH occasions within a PRACH slot may be needed or desired. Another reason for TDMed PRACH occasions in a PRACH slot may be that fine-granular SSB to PRACH slot mapping is desired while still providing PRACH occasions for all or many SSBs in each PRACH slot. Since the associated PO(s)/PRU(s) may not be allocated before the end of the PRACH slot, there may inevitably be a larger than 16 μs gap between the PRACH occasion(s) ending earlier than the end of the PRACH slot and the associated PO(s)/PRU(s). This means that when the UE uses such a PRACH occasion, it has to perform one CCA operation before transmitting the preamble and then a second CCA operation before transmitting the msgA PUSCH (and both CCA operations have to be successful). In order to increase the chances that the CCA operation is successful also for the msgA PUSCH transmission, multiple TDMed and/or FDMed (in different CCA bandwidth chunks) CFRA POs/PRUs may be configured for the PRACH slot.

Since CFRA is configured using dedicated RRC signaling, the UE may be the only one using the CFRA PO(s)/PRU(s) configured for a PRACH slot. Hence, the PRUs may not have to be mapped to unique RO-preamble combinations, but instead the UE can try CCA for all or any of the FDMed and/or TDMed CFRA PO(s)/PRU(s) associated with the PRACH slot in which the UE transmits a preamble, irrespective of which PRACH occasion and CFRA preamble the UE used.

According to an exemplary embodiment, for CFRA with two-step RA type in unlicensed/shared spectrum operation, a set of PRUs which are mapped to (each of) all preambles in all ROs in one PRACH slot may be determined, e.g., by a network node (e.g. gNB), and the first available PRU in the CCA process may be used for the msgA PUSCH transmission. Here the term “a set of PRUs” may be all valid PRUs based on the msgA PUSCH configurations in dedicated signaling for configuring two-step CFRA or they can be a subset of the valid PRUs defined by the msgA PUSCH configurations in dedicated RRC signaling for configuring two-step CFRA.

As described in section 8.1A of 3GPP TS 38.213 V16.1.0, a PUSCH occasion is valid if it does not overlap in time and frequency with any PRACH occasion associated with either a Type-1 random access procedure or a Type-2 random access procedure. Additionally, if a UE is provided the parameter tdd-UL-DL-ConfigurationCommon, a PUSCH occasion is valid if
it is within UL symbols, or
it does not precede a SS/PBCH block in the PUSCH slot and starts at least Ngap symbols after a last downlink symbol and at least Ngap symbols after a last SS/PBCH block symbol, where Ngap is provided in Table 8.1-2 of 3GPP TS 38.213 V16.1.0.

According to the existing configuration, e.g. as described in section 8.1A of 3GPP TS 38.213 V16.1.0, a preamble may not be mapped to more than one PRU. Hence, some modification of the CFRA configuration may be needed.

FIG. 3E is a diagram illustrating an exemplary CFRA configuration information element according to another embodiment of the present disclosure. In the exemplary CFRA-TwoStep (which may be renamed CFRA-TwoStepRA) IE shown in FIG. 3E, a parameter eachPreambleMapsToAllPRUsPerPRACH-Slot is introduced, which may indicate whether regular mapping (i.e. mapping that may be used when NR operates in licensed spectrum) is used, or whether the configured CFRA preamble(s) may need to be mapped to all valid PRUs associated with the PRACH slot.

In accordance with some exemplary embodiments, if the higher layer parameter eachPreambleMapsToAllPRUsPerPRACH-Slot is not configured, which means that the configuration is for CBRA or the parameter eachPreambleMapsToAllPRUsPerPRACH-Slot is not provided in configuration signaling for CFRA, the regular preamble to PRU mapping (e.g. according to mapping scheme I) may be applied. If the higher layer parameter eachPreambleMapsToAllPRUsPerPRACH-Slot is configured, each of the all preamble indexes from valid PRACH occasions in a PRACH slot may be mapped to all the valid PUSCH occasions and associated DMRS resources (i.e. all PRUs) associated with the PRACH slot (also called mapping scheme IV).

In accordance with some exemplary embodiments, for a contention-based Type-2 random access procedure, a mapping order (e.g. mapping scheme I) may be applied for mapping between preambles and PRUs as described in 3GPP TS 38.213 V16.1.0. For a contention-free Type-2 random access procedure, if the higher layer parameter eachPreambleMapsToAllPRUsPerPRACH-Slot is not configured, all preamble indexes configured for a PRACH slot may be mapped to the same valid PUSCH occasion and the associated DMRS resource (e.g. mapping scheme II). For example, in the case that multiple valid PUSCH occasions and associated DMRS resources (i.e. multiple PRUs) are configured for a PRACH slot, all of the preamble(s) may be mapped to the first PRU, e.g. according to the mapping order for the contention-based Type-2 random access procedure. If the higher layer parameter eachPreambleMapsToAllPRUsPerPRACH-Slot is configured, each of the all preamble indexes from valid PRACH occasions in a PRACH slot may be mapped to all the valid PUSCH occasions and associated DMRS resources (i.e. all PRUs) associated with the PRACH slot (e.g. mapping scheme IV).

In accordance with some exemplary embodiments, the PRUs indicated by one or more configuration parameters may be more for each PRACH slot than desired. In order to reduce the number to a desired number, an additional RRC IE/parameter, e.g. nrofValidPRUsPerPRACH-Slot, may be introduced in the CFRA-TwoStep-r16 IE, indicating the number of valid PRUs to which the CFRA preambles of the PRACH slot may be mapped. In an embodiment, each of all the CFRA preambles of the PRACH slot may be mapped to all of the indicated number of valid PRUs. As an example, the IE/parameter nrofValidPRUsPerPRACH-Slot may be of type INTEGER and have the following abstract syntax notation one (ASN.1) definition:

nrofValidPRUsPerPRACH-Slot INTEGER (1 . . . maxNrOfPRUsPerPRACH-Slot) OPTIONAL

In this ASN.1 definition, maxNrOfPRUsPerPRACH-Slot may be a specified constant, indicating the maximum number of PRUs per PRACH slot. Thus, the nrofValidPRUsPerPRACH-Slot IE/parameter may point out a subset of the valid PRUs that would otherwise be configured for a PRACH slot. In order to identify which PRUs this subset may consist of, there may be a rule e.g. stating that the subset consists of the nrofValidPRUsPerPRACH-Slot first valid PRUs where the valid PRUs are ordered according to a mapping order (e.g. mapping scheme I). As described in section 8.1A of 3GPP TS 38.213 V16.1.0, the mapping order may be: first in increasing order of frequency resource indexes of frequency multiplexed POs, second in increasing order of DMRS resource indexes within a PO, third in increasing order of time resource indexes for time multiplexed POs within a PUSCH slot, fourth in increasing order of indexes of PUSCH slots.

In accordance with some exemplary embodiments, the nrofValidPRUsPerPRACH-Slot IE/parameter may be used together with the eachPreambleMapsToAllPRUsPerPRACH-Slot IE/parameter. In an embodiment, the use of the nrofValidPRUsPerPRACH-Slot IE/parameter may render the eachPreambleMapsToAllPRUsPerPRACH-Slot IE/parameter redundant, since the existence of the nrofValidPRUsPerPRACH-Slot IE/parameter may implicitly mean that each of all the (CFRA) preambles of a PRACH slot may need to be mapped to all of the valid PRUs associated with the PRACH slot.

In accordance with some exemplary embodiments, the eachPreambleMapsToAllPRUsPerPRACH-Slot IE/parameter and/or the nrofValidPRUsPerPRACH-Slot IE/parameter may not be used. In an embodiment, it may be predetermined that when two-step CFRA is configured and the NR system is operating in shared/unlicensed spectrum, then all/each of the (CFRA) preambles of a PRACH slot may need to be mapped to all of the valid PRUs associated with the PRACH slot.

In accordance with some exemplary embodiments, one or more msgA PUSCH configurations may be provisioned for CFRA. For CBRA, there may be two msgA PUSCH configurations when group B preamble is configured. For CFRA, there may be no need to have two preamble groups, thus one msgA PUSCH configuration may be enough. In an embodiment, the number of msgA PUSCH configuration(s) may be fixed e.g. to be one. As an example, the number of msgA PUSCH configurations for CFRA may be up to 2 per BWP for CBRA. In another embodiment, if multiple configurations are configured for CFRA, one of the multiple configurations (e.g. the first or second one, etc.) used for CFRA may be predetermined, and/or signaled by RRC signaling.

It can be realized that parameters, variables and settings related to the signaling transmission and resource configuration described herein are just examples. Other suitable parameter settings, the associated configurations and the specific values thereof may also be applicable to implement the proposed methods.

It is noted that some embodiments of the present disclosure are mainly described in relation to 5G or NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

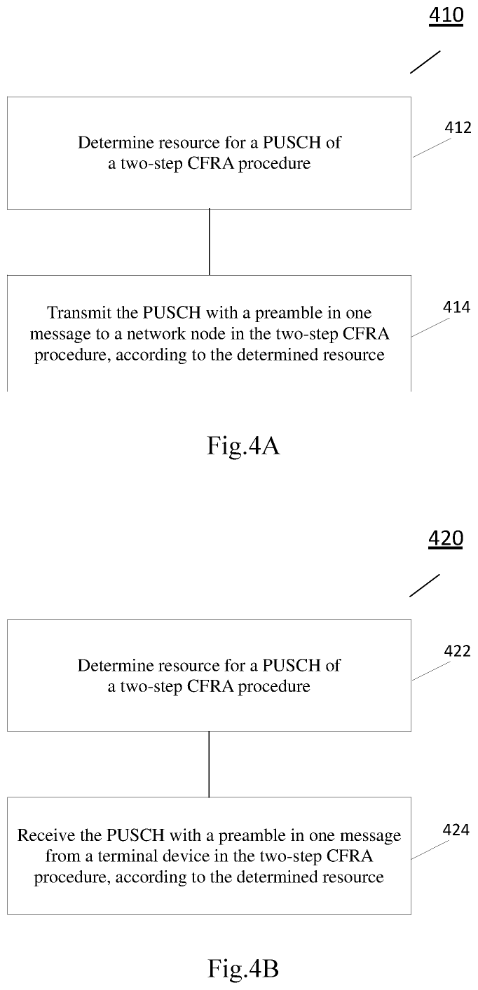

FIG. 4A is a flowchart illustrating a method 410 according to some embodiments of the present disclosure. The method 410 illustrated in FIG. 4A may be performed by a terminal device or an apparatus communicatively coupled to the terminal device. In accordance with an exemplary embodiment, the terminal device such as a UE may be configured to connect to a network node such as a gNB, for example, by performing a RA procedure (e.g., a two-step CFRA procedure).

According to the exemplary method 410 illustrated in FIG. 4A, the terminal device may determine resource for a PUSCH of a two-step CFRA procedure, as shown in block 412. According to the determined resource, the terminal device may transmit the PUSCH with a preamble in one message (e.g. message A, etc.) to a network node in the two-step CFRA procedure, as shown in block 414. In accordance with an exemplary embodiment, the terminal device may optionally receive, from the network node, signaling information (e.g. RRC signaling, etc.) for message A PUSCH transmission of the two-step CFRA procedure. In an embodiment, the received signaling information may be used for determining the resource for the PUSCH of the two-step CFRA procedure.

FIG. 4B is a flowchart illustrating a method 420 according to some embodiments of the present disclosure. The method 420 illustrated in FIG. 4B may be performed by a network node or an apparatus communicatively coupled to the network node. In accordance with an exemplary embodiment, the network node may comprise a base station such as a gNB. The network node may be configured to communicate with one or more terminal devices such as UEs which can connect to the network node by performing a RA procedure (e.g., a two-step CFRA procedure).

According to the exemplary method 420 illustrated in FIG. 4B, the network node may determine resource for a PUSCH of a two-step CFRA procedure, as shown in block 422. According to the determined resource, the network node may receive the PUSCH with a preamble in one message (e.g. message A, etc.) from a terminal device (e.g. the terminal device as described with respect to FIG. 4A) in the two-step CFRA procedure, as shown in block 424. In accordance with an exemplary embodiment, the network node may optionally transmit to the terminal device signaling information (e.g. RRC signaling, etc.) for message A PUSCH transmission of the two-step CFRA procedure. In an embodiment, the terminal device may use the signaling information to determine the resource for the PUSCH of the two-step CFRA procedure.

It can be appreciated that the steps, operations and related configurations of the method 420 illustrated in FIG. 4B may correspond to the steps, operations and related configurations of the method 410 illustrated in FIG. 4A. It also can be appreciated that the resource for the PUSCH determined by the network node according to the method 420 may correspond to the resource for the PUSCH determined by the terminal device according to the method 410. Thus, the determined resource for the PUSCH as described with respect to FIG. 4A and FIG. 4B may have the same or similar contents and/or feature elements. Correspondingly, the determination of the resource for the PUSCH according to the methods 410 and 420 may be based on the same or similar parameter(s) and/or rule(s).

In accordance with some exemplary embodiments, the determined resource for the PUSCH may include a PUSCH occasion (e.g. as shown in FIG. 3C). The PUSCH occasion may be preconfigured or dynamically allocated for the two-step CFRA procedure. According to an embodiment, one or more PRUs may be configured for two-step CFRA in this PUSCH occasion.

In accordance with some exemplary embodiments, the determined resource for the PUSCH may be indicated by one or more of:
a preamble group associated to PUSCH configuration (e.g., the parameter msgA-PUSCH-PreambleGroup-r16, etc.);
a number of slots containing one or more PUSCH occasions (e.g., the parameter nrofSlotsMsgA-PUSCH-r16, etc.);
a number of time domain PUSCH occasions in each slot (e.g., the parameter nrofMsgA-PO-PerSlot-r16, etc.); and
a number of PUSCH occasions frequency-division multiplexed in one time instance (e.g., the parameter nrofMsgA-PO-FDM-r16, etc.).

In accordance with some exemplary embodiments, the determined resource for PUSCH may be indicated by one or more parameters having default values. In an embodiment, some or all of the parameters such as msgA-PUSCH-PreambleGroup-r16, nrofSlotsMsgA-PUSCH-r16, nrofMsgA-PO-PerSlot-r16 and nrofMsgA-PO-FDM-r16 may be optional, or set to the respective default values such as “groupA”, “1”, “one” and “one”, as described with respect to FIG. 3A.

In accordance with some exemplary embodiments, the determination of the resource for the PUSCH may be based at least in part on one or more of:
a number of PRUs corresponding to each PRACH slot (e.g. the parameter nrofPRUsPerPRACH-Slot, etc.); and
whether only a single PRU is valid for each PRACH slot (e.g. the parameter singlePRU-PerPRACH-Slot, etc.).

In accordance with some exemplary embodiments, the determined resource for PUSCH may include a PRU. According to an embodiment, it may be possible that a single PRU per PRACH slot is configured for two-step CFRA. In this case, the determined PRU may be the only one PRU valid for two-step CFRA in the PUSCH occasion corresponding to the associated PRACH slot. According to another embodiment, the PRU may be one of multiple PRUs per PRACH slot configured for two-step CFRA.

In accordance with some exemplary embodiments, the determination of the resource for the PUSCH may be based at least in part on one or more of:
a number of ports per code division multiplexing (CDM) group (e.g. 1 port per CDM group, etc.);
indication information of one or more CDM groups (e.g. CDM group 0, etc.); and
a scrambling identifier (e.g. a scrambling ID for UL DMRS scrambling initialization for CP-OFDM, which may be indicated by the parameter msgA-ScramblingID0, etc.).

In accordance with some exemplary embodiments, the PRU determined for the PUSCH may be the only PRU in one PUSCH occasion configured for the two-step CFRA procedure. According to an embodiment, the PRU may be mapped to all preambles configured for the two-step CFRA procedure in a PRACH slot.

In accordance with some exemplary embodiments, the PRU determined for the PUSCH may be selected from a set of PRUs in one or more PUSCH occasions. According to an embodiment, the selection of the PRU may be based at least in part on one or more of:
an identifier of the preamble in the message (e.g. according to formula (3) and formula (4), etc.);
an identifier of a SSB which is associated with the preamble in the message (e.g. according to formula (1) and formula (2), etc.);
an identifier of the PRU (e.g., the parameter MsgA-PRU-ID-PerPO, the parameter MsgA-PRU-ID, etc.); and
a predetermined ordering rule (e.g. the 1st DMRS port and the 1st DMRS sequence in the 1st PUSCH occasion, etc.).

In accordance with some exemplary embodiments, the determined resource for PUSCH may include two or more PRUs (e.g. as shown in FIG. 3D). The PRUs may be preconfigured or dynamically allocated for the two-step CFRA procedure. According to an exemplary embodiment, the two or more PRUs may be mapped to at least part of preambles which are configured for the two-step CFRA procedure in a PRACH slot, according to a first mapping ratio (e.g. the mapping ratio calculated by formula (5), etc.). In accordance with some exemplary embodiments, the first mapping ratio may be relevant to or independent of a second mapping ratio which is used for preamble to PRU mapping in another PRACH slot different from the PRACH slot. According to an embodiment, the mapping between the at least part of preambles and the two or more PRUs may be one to one mapping. It can be appreciated that the mapping between the at least part of preambles and the two or more PRUs may also be one to multiple mapping, or multiple to one mapping, as required.

In accordance with some exemplary embodiments, the preamble in the message of the two-step CFRA procedure may be mapped to at least one of the two or more PRUs. The preamble to PRU mapping may be utilized to determine the PRU used for the PUSCH in the message.

In accordance with some exemplary embodiments, the two-step CFRA procedure may be operated in a sharable spectrum (e.g. unlicensed/shared spectrum, etc.). According to an exemplary embodiment, the two or more PRUs may be mapped to each of all preambles configured for the two-step CFRA procedure in a PRACH slot. In this case, the preamble to PRU mapping may be one to multiple mapping. According to an exemplary embodiment, the determined resource for the PUSCH of the two-step CFRA procedure operated in the sharable spectrum (e.g. the operation in NR-U) may be a first available PRU in a CCA process.

In accordance with some exemplary embodiments, the determination of the resource for the PUSCH may be based at least in part on: whether each of preambles for the two-step CFRA procedure in a PRACH slot is mapped to all PRUs which are valid for the two-step CFRA procedure and associated with the PRACH slot (e.g. the parameter eachPreambleMapsToAllPRUsPerPRACH-Slot, etc.).

In accordance with some exemplary embodiments, the determination of the resource for the PUSCH may be based at least in part on: a number of PRUs which are valid for the two-step CFRA procedure and associated with a PRACH slot (e.g. the parameter nrofValidPRUsPerPRACH-Slot, etc.).

In accordance with some exemplary embodiments, the determination of the resource for the PUSCH may be based at least in part on:
a number of PUSCH configurations available for the two-step CFRA procedure; and
which PUSCH configuration is used in the two-step CFRA procedure.

In accordance with some exemplary embodiments, the determination of the resource for the PUSCH may be based at least in part on: predetermined information for message A PUSCH transmission in the two-step CFRA procedure (e.g. some hardcoded information for msgA PUSCH transmission of two-step CFRA, etc.).

Various exemplary embodiments according to the present disclosure may enable PRU determination for the CFRA with two-step RA type e.g. according to the number of PRUs needed. In accordance with exemplary embodiments, one or more PRUs per PRACH slot may be allowed for msgA PUSCH transmission in a two-step CFRA procedure, and different mapping between preambles and PRUs may be applied for various application cases. The PRU used for the msgA PUSCH transmission may be determined or selected, e.g. according to specific signaling and/or a predetermined rule. Application of various exemplary embodiments can enhance network performance with minimized reserved resource overhead, while keeping the necessary flexibility for the SSB to preamble/RO mapping without impact on a four-step RA procedure and a two-step CBRA procedure.

The various blocks shown in FIGS. 4A-4B may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

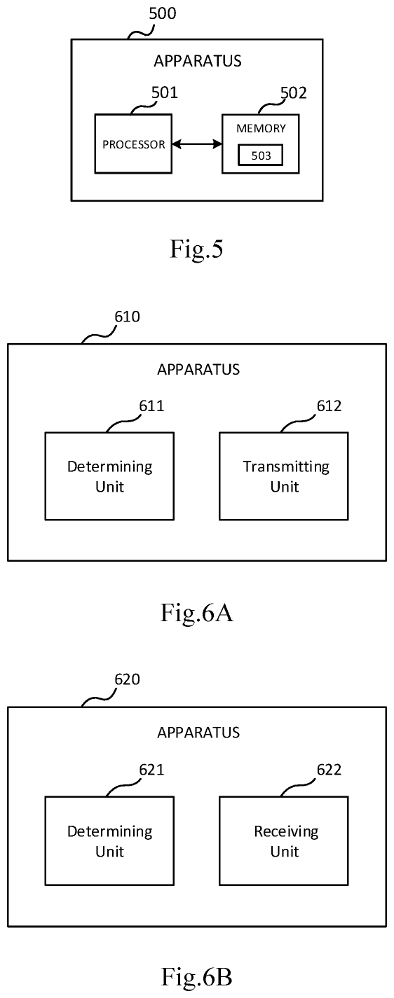

FIG. 5 is a block diagram illustrating an apparatus 500 according to various embodiments of the present disclosure. As shown in FIG. 5, the apparatus 500 may comprise one or more processors such as processor 501 and one or more memories such as memory 502 storing computer program codes 503. The memory 502 may be non-transitory machine/processor/computer readable storage medium. In accordance with some exemplary embodiments, the apparatus 500 may be implemented as an integrated circuit chip or module that can be plugged or installed into a terminal device as described with respect to FIG. 4A, or a network node as described with respect to FIG. 4B. In such case, the apparatus 500 may be implemented as a terminal device as described with respect to FIG. 4A, or a network node as described with respect to FIG. 4B.

In some implementations, the one or more memories 502 and the computer program codes 503 may be configured to, with the one or more processors 501, cause the apparatus 500 at least to perform any operation of the method as described in connection with FIG. 4A. In other implementations, the one or more memories 502 and the computer program codes 503 may be configured to, with the one or more processors 501, cause the apparatus 500 at least to perform any operation of the method as described in connection with FIG. 4B. Alternatively or additionally, the one or more memories 502 and the computer program codes 503 may be configured to, with the one or more processors 501, cause the apparatus 500 at least to perform more or less operations to implement the proposed methods according to the exemplary embodiments of the present disclosure.

FIG. 6A is a block diagram illustrating an apparatus 610 according to some embodiments of the present disclosure. As shown in FIG. 6A, the apparatus 610 may comprise a determining unit 611 and a transmitting unit 612. In an exemplary embodiment, the apparatus 610 may be implemented in a terminal device such as a UE. The determining unit 611 may be operable to carry out the operation in block 412, and the transmitting unit 612 may be operable to carry out the operation in block 414. Optionally, the determining unit 611 and/or the transmitting unit 612 may be operable to carry out more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise a determining unit 621 and a receiving unit 622. In an exemplary embodiment, the apparatus 620 may be implemented in a network node such as a base station. The determining unit 621 may be operable to carry out the operation in block 422, and the receiving unit 622 may be operable to carry out the operation in block 424. Optionally, the determining unit 621 and/or the receiving unit 622 may be operable to carry out more or less operations to implement the proposed methods according to the exemplary embodiments of the present disclosure.

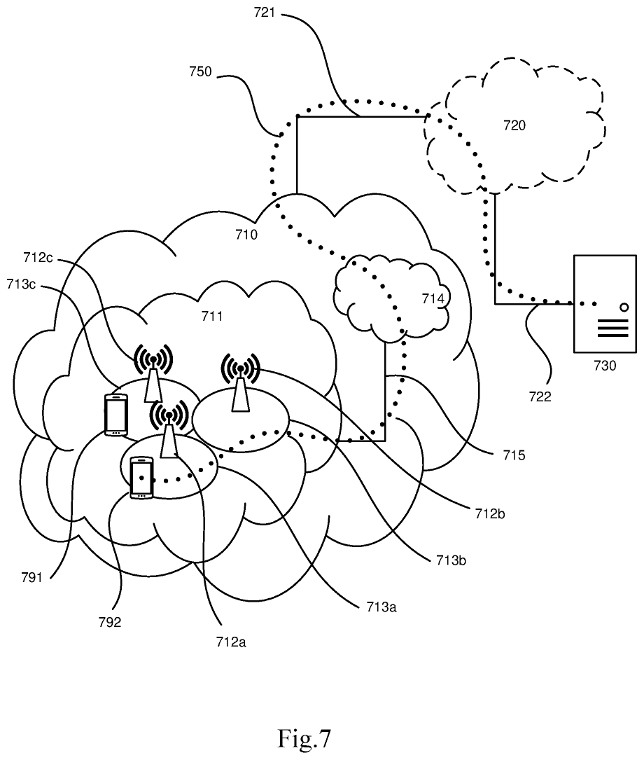

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

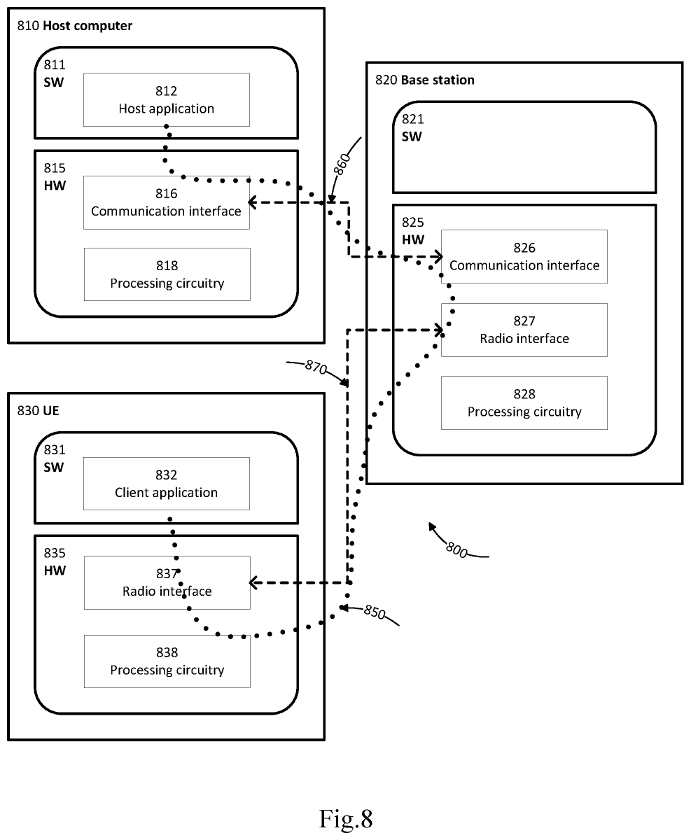

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

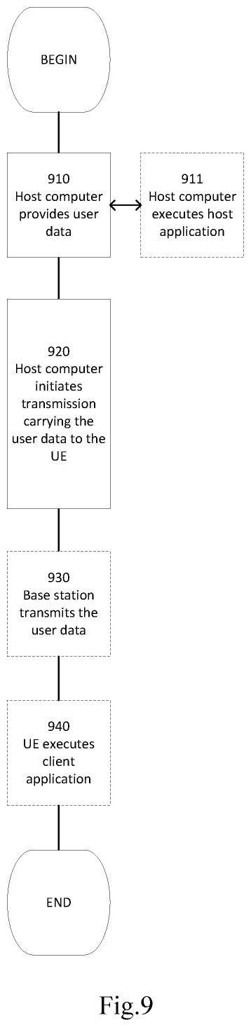

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

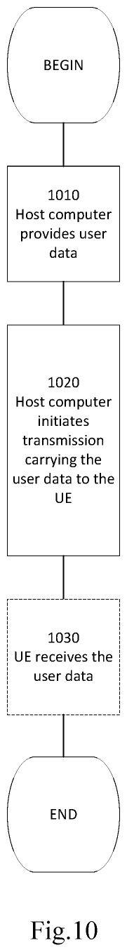

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

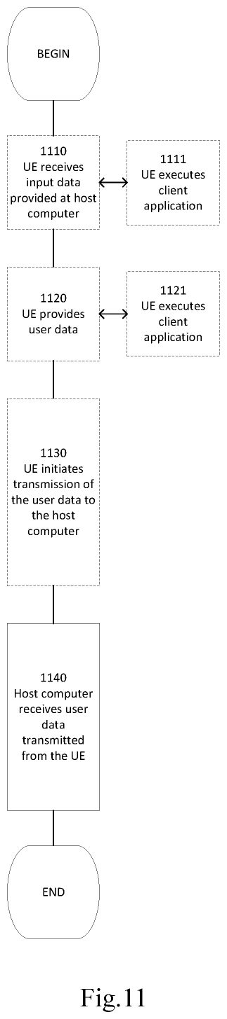

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

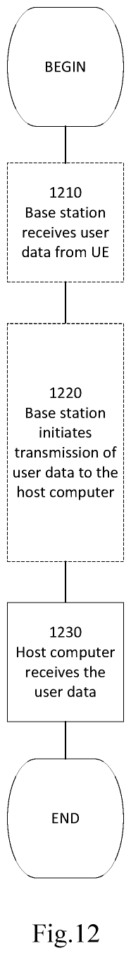

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 420 as describe with respect to FIG. 4B.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 420 as describe with respect to FIG. 4B.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 410 as describe with respect to FIG. 4A.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 410 as describe with respect to FIG. 4A.

According to some exemplary embodiments, there is provided a method implemented in a communication system which may include a host computer, a base station and a UE. The method may comprise, at the host computer, receiving user data transmitted to the base station from the UE which may perform any step of the exemplary method 410 as describe with respect to FIG. 4A.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 410 as describe with respect to FIG. 4A.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 420 as describe with respect to FIG. 4B.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 420 as describe with respect to FIG. 4B.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a terminal device, comprising:
determining resource for a physical uplink shared channel of a two-step contention-free random access procedure; and
transmitting the physical uplink shared channel with a preamble in one message to a network node in the two-step contention-free random access procedure, according to the determined resource.

2. The method according to claim 1, wherein the determined resource includes a physical uplink shared channel occasion.

3. The method according to claim 1, wherein the determined resource is indicated by one or more of:
a preamble group associated to physical uplink shared channel configuration;
a number of slots containing one or more physical uplink shared channel occasions;
a number of time domain physical uplink shared channel occasions in each slot; and
a number of physical uplink shared channel occasions frequency-division multiplexed in one time instance.

4. The method according to claim 1, wherein the determined resource is indicated by one or more parameters having default values.

5. The method according to claim 1, wherein the determination of the resource for the physical uplink shared channel is based at least in part on one or more of:
a number of physical uplink shared channel resource units corresponding to each physical random access channel slot; and
whether only a single physical uplink shared channel resource unit is valid for each physical random access channel slot.

6. The method according to claim 1, wherein the determined resource includes a physical uplink shared channel resource unit.

7. The method according to claim 6, wherein the determination of the resource for the physical uplink shared channel is based at least in part on one or more of:
a number of ports per code division multiplexing group;
indication information of one or more code division multiplexing groups; and
a scrambling identifier.

8. The method according to claim 6, wherein the physical uplink shared channel resource unit is the only physical uplink shared channel resource unit in one physical uplink shared channel occasion configured for the two-step contention-free random access procedure.

9. The method according to claim 6, wherein the physical uplink shared channel resource unit is mapped to all preambles configured for the two-step contention-free random access procedure in a physical random access channel slot.

10. The method according to claim 6, wherein the physical uplink shared channel resource unit is selected from a set of physical uplink shared channel resource units in one or more physical uplink shared channel occasions.

11. The method according to claim 10, wherein the selection of the physical uplink shared channel resource unit is based at least in part on one or more of:
an identifier of the preamble in the message;
an identifier of a synchronization signal and physical broadcast channel block which is associated with the preamble in the message;
an identifier of the physical uplink shared channel resource unit; and
a predetermined ordering rule.

12-22. (canceled)

23. The method according to claim 1, further comprising:
receiving, from the network node, signaling information for message A physical uplink shared channel transmission of the two-step contention-free random access procedure.

24. The method according to claim 1, wherein the determination of the resource for the physical uplink shared channel is based at least in part on: predetermined information for message A physical uplink shared channel transmission in the two-step contention-free random access procedure, wherein the predetermined information is included in a radio resource control, RRC, signaling.

25. A method performed by a network node, comprising:
determining resource for a physical uplink shared channel of a two-step contention-free random access procedure; and
receiving the physical uplink shared channel with a preamble in one message from a terminal device in the two-step contention-free random access procedure, according to the determined resource.

26. The method according to claim 25, wherein the determined resource includes a physical uplink shared channel occasion.

27. The method according to claim 25, wherein the determined resource is indicated by one or more of:
a preamble group associated to physical uplink shared channel configuration;
a number of slots containing one or more physical uplink shared channel occasions;
a number of time domain physical uplink shared channel occasions in each slot; and
a number of physical uplink shared channel occasions frequency-division multiplexed in one time instance.

28. (canceled)

29. (canceled)

30. The method according to claim 25, wherein the determined resource includes a physical uplink shared channel resource unit.

31-33. (canceled)

34. The method according to claim 30, wherein the physical uplink shared channel resource unit is selected from a set of physical uplink shared channel resource units in one or more physical uplink shared channel occasions.

35-47. (canceled)

48. The method according to claim 25, wherein the determination of the resource for the physical uplink shared channel is based at least in part on: predetermined information for message A physical uplink shared channel transmission in the two-step contention-free random access procedure, wherein the predetermined information is included in a radio resource control, RRC, signaling.

49. A terminal device, comprising:
one or more processors; and
one or more memories comprising computer program codes,
the one or more memories and the computer program codes configured to, with the one or more processors, cause the terminal device at least to:
determine resource for a physical uplink shared channel of a two-step contention-free random access procedure; and
transmit the physical uplink shared channel with a preamble in one message to a network node in the two-step contention-free random access procedure, according to the determined resource.

50-54. (canceled)
